(19) United States
(12) Patent Application Publication
(10) Pub. No.: US 2013/0325579 A1
(43) Pub. Date: Dec. 5, 2013

(54) SYSTEMS AND METHODS TO PROCESS LOYALTY BENEFITS

(71) Applicant: Visa International Service Association, San Francisco, CA (US)

(72) Inventors: Diane C. Salmon, Lafayette, CA (US); Nancy L. Kim, San Francisco, CA (US); James Alan VonDerheide, La Canada, CA (US)

(73) Assignee: Visa International Service Association, San Francisco, CA (US)

(21) Appl. No.: 13/897,043

(22) Filed: May 17, 2013

Related U.S. Application Data
(60) Provisional application No. 61/655,455, filed on Jun. 4, 2012.

(51) Int. Cl. G06Q 30/02

(52) U.S. Cl. CPC G06Q 30/0228
USPC 705/14.29

(57) ABSTRACT

A system and method to provide a universal loyalty currency, facilitate exchange of loyalty benefits, and allow payments using loyalty benefits. A method includes: receiving registration information to associate account information of a payment account with at least one loyalty account to enable conversion of first loyalty benefits to second loyalty benefits; receiving, for a transaction, an authorization request identifying the account information and requesting the use of the second loyalty benefits to fund at least a portion of the transaction; and processing the transaction using the second benefits converted from the first loyalty benefits hosted in the loyalty account and funds from the payment account.

### RELATED APPLICATIONS

The present application claims the benefit of the filing date of Prov. U.S. Pat. App. Ser. No. 61/655,455, filed Jun. 4, 2012 and entitled “Systems and Methods to Process Loyalty Benefits,” the entire disclosure of which is hereby incorporated herein by reference.

The present application relates to: U.S. patent application Ser. No. 13/543,369, filed Jul. 6, 2012 and entitled “Systems and Methods for Customer Loyalty Program”; U.S. patent application Ser. No. 13/485,645, filed May 31, 2012, assigned U.S. Pat. App. Pub. No. 2012/0310838, and entitled “Local Usage of Electronic Tokens in a Transaction Processing System”; U.S. patent application Ser. No. 13/432,249, filed Mar. 28, 2012, assigned U.S. Pat. App. Pub. No. 2012/0253914, and entitled “Universal Loyalty Program Device”; U.S. patent application Ser. No. 12/704,445, filed Feb. 11, 2010, assigned U.S. Pat. App. Pub. No. 2010/0211469, and entitled “Point of Interaction Loyalty Currency Redemption in a Transaction”; U.S. patent application Ser. No. 13/865,101, filed Apr. 17, 2013, and entitled “Systems and Methods to Use Transaction Authorization Communications to Process Offers”; U.S. patent application Ser. No. 13/356,506, filed Jan. 23, 2012, assigned U.S. Pat. App. Pub. No. 2012/0191525, and entitled “Systems and Methods to Facilitate Loyalty Reward Transactions”; and U.S. patent application Ser. No. 13/237,457, filed Sep. 20, 2011, assigned U.S. Pat. App. Pub. No. 2012/0078697, and entitled “Systems and Methods to Program Operations for Interaction with Users”, the disclosures of which applications are incorporated herein by reference in their entireties.

### FIELD OF THE TECHNOLOGY

At least some embodiments of the present disclosure relate to the processing of loyalty benefits, such as points, miles awarded in loyalty programs.

### BACKGROUND

Some businesses provide customer loyalty programs. Frequently these programs employ some type of “give back” to customers to encourage repeat purchases or continued association.

Many loyalty programs fall into one of the following categories:

Appreciation: Giving the customer more of a product or service.

Reward: Giving the customer a product unrelated to the purchased product or service (e.g., a bank giving away a toaster).

Rebate: Giving customers money back for a particular purchase.

Discount: Giving customers a discount off of future purchases based on a type or value of a current purchase.

Such loyalty programs may be associated with a credit card, or other financial vehicle, and processed through a payment and settlement system.

A conventional credit card processing system includes a cardholder who makes a purchase from a merchant using a credit card of the cardholder issued by an issuer, such as the cardholder's financial institution or bank, to identify a payment account. To process a transaction, the merchant typically uses a point-of-sale device, which transmits a payment authorization request to an acquirer such as the merchant's bank. The acquirer transmits the payment authorization request, which conventionally includes the merchant identification, the credit card number, and the requested dollar amounts, to the issuer through a transaction handler or payment system. If the issuer determines that the authorization requests should be granted, the issuer generates an authorization response message indicating that the request is approved, which is transmitted through the transaction handler to the acquirer and ultimately to the merchant. The merchant then completes the transaction with the cardholder. During settlement, the acquirer sends the charges through the transaction handler to be processed by the issuer, which pays the acquirer and later charges the cardholder for the purchase and reflects such charges in a cardholder statement; and then the acquirer pays the merchant for the cardholder's purchases.

Millions of transactions occur daily through the use of payment cards, such as credit cards, debit cards, prepaid cards, etc. Corresponding records of the transactions are recorded in databases for settlement and financial record keeping (e.g., to meet the requirements of government regulations). Such data can be analyzed for trends, statistics, and other analyses. Sometimes, such data are mined for specific advertising goals, such as to provide targeted offers to account holders, as described in PCT Pub. No. WO 2008/067543 A2, published on Jun. 5, 2008 and entitled “Techniques for Targeted Offers,” which is hereby incorporated herein by reference.

In some cases, coupons (e.g., physical coupons distributed in published magazines with accompanying advertisements) may be used in some of these transactions. These coupons are typically targeted to individual consumers and offer a one-time discount for a single purchase of a good or service. However, consumers often view such coupons as being mundane or dull, and generating significant consumer interest in the coupons is frequently challenging to product marketers.

In other cases, a local community engaging in transactions desires to promote businesses that are located within a defined city or other local region. This is due in part to a growing interest in promoting the consumption of locally-produced products. However, it continues to be difficult for a community to retain income that is earned locally by having or encouraging that income to be spent locally. Some communities have experimented with the use of local currencies to accomplish this result. However, the use of such currencies may raise legal issues and also may increase the risk of inducing localized inflation or deflation.

### BRIEF DESCRIPTION OF THE DRAWINGS

The embodiments are illustrated by way of example and not limitation in the figures of the accompanying drawings in which like references indicate similar elements.

FIG. 1 illustrates a transactional flow involving multiple transactions and entities, including transactions within a local region or network, according to one embodiment.

FIG. 2 illustrates token data record according to one embodiment.

FIG. 3 illustrates a trophy data record according to one embodiment.

FIG. 4 illustrates a token processing infrastructure according to one embodiment.

FIG. 5 illustrates a system to provide services based on transaction data according to one embodiment.

FIG. 6 illustrates the generation of an aggregated spending profile according to one embodiment.

FIG. 7 shows a method to generate an aggregated spending profile according to one embodiment.

FIG. 8 shows a system to provide information based on transaction data according to one embodiment.

FIG. 9 illustrates a transaction terminal according to one embodiment.

FIG. 10 illustrates an account identifying device according to one embodiment.

FIG. 11 illustrates a data processing system according to one embodiment.

FIG. 12 shows the structure of account data for providing loyalty programs according to one embodiment.

FIG. 13 shows a system to provide real-time messages according to one embodiment.

FIG. 14 shows a method to provide real-time messages according to one embodiment.

FIG. 15 shows a network connection of point-of-sale devices, acquirer processors, a transaction handler, promotion/award determination engines and associated databases, and issuer processors according to one embodiment.

FIG. 16 shows a block diagram of a flow of information from a cardholder through a system to grant, accumulate, and redeem points according to one embodiment.

FIG. 17 shows a detail of a database system.

FIG. 18 shows a computer system compatible with implementing the system and method of this disclosure.

FIG. 19 illustrates a system configured to process loyalty benefits according to one embodiment.

FIG. 20 shows a method to redeem loyalty benefits according to one embodiment.

### DETAILED DESCRIPTION

### Introduction

In one embodiment, a group of businesses may give points to customers through a credit, debit, or pre-paid financial arrangement (collectively referred to hereinafter as a “card”) employing a transaction processing system. Using a specialized or non-specialized card at a participating merchant in the group, a customer earns points that can be used at any merchant within the group. Some details and examples are provided in the sections entitled “LOYALTY NETWORK” and “LOYALTY COALITION.”

At least some embodiments of the present disclosure relate to the processing of transactions, such as payments made via payment cards such as credit cards, debit cards, prepaid cards, etc., and the managing of electronic tokens associated with various entities (e.g., users of a transactional token processing system) involved in these transactions (e.g., using transaction data obtained during this processing, such as by a transaction handler). In one example, each of the tokens provides a benefit (e.g., a discount of 30%) to a consumer when making a purchase using a credit card or other payment card. In another example, the tokens are limited to usage in a defined local region or network (e.g., having a common electronic network address or domain).

### Transaction Token

As used herein, “transactional token” refers generally to an electronic token that provides a benefit to an entity (e.g., when the token is applied to a transaction involving the entity, or when the token is accumulated with other tokens by a single user or entity). These transactional tokens may be generated and issued to various entities (e.g., consumers and merchants) by a token processing system (discussed in more detail below). In some embodiments, the transactional token may provide a benefit that is the same or similar to that of a coupon (e.g., a 10% off coupon), but transactional tokens are not limited to use solely as a coupon (e.g., transactional tokens may have other attributes and characteristics as described below). Entities to which tokens are issued may be users of the token processing system (e.g., a user that accesses the system via a user device or user terminal). These users may access information about their tokens, for example, by logging onto this system. When the user is merchant, the user may specify the particular goods or services and conditions under which a token may be used in a transaction involving the merchant's goods or services.

In one embodiment, the token processing system maintains data for the tokens of each user (e.g., a unique identifier for each token that is associated with that user). The token processing system may, for example, maintain data regarding various attributes for each token and also transaction histories associated with each token. For example, a first attribute for a token may be a discount to be applied to a purchase. Another attribute may be a loyalty reward point allocation that is associated with use of the token in a transaction. As a token is used, transaction data associated with its use may be stored as a token transaction history that remains permanently associated with the token.

In one embodiment, a method for the use of transactional tokens comprises the following steps: (i) generating transactional tokens (e.g., including a first token to offer a discount for making a purchase from a merchant); (ii) associating each of the transactional tokens with one of a group of users (e.g., the first token is associated with a first user); (iii) monitoring usage of the transactional tokens in a multitude of transactions by the users; and (iv) responsive to the monitoring, updating the first token from a first state (e.g., a discount of 30%) to a second state (e.g., the discount has been applied, but the purchaser now holds a trophy due to making the purchase). The tokens may be generated and monitored using a token processing system, which may interact with and use transaction data received by a transaction handler that is processing each of the transactions.

In one embodiment, the token processing system permits users to transfer tokens from one user or entity to another. These entities may be users of the token processing system, but in other embodiments, an entity that is not a user may receive the token.

In another embodiment, a transactional token may be used or applied to more than one transaction. The token may change state as each of these transaction occurs (i.e., as the token is applied to each of the transactions by the user that is currently holding the token). The token may further change state based on other data collected and/or analyzed by the token processing system (e.g., a change in merchant inventory, or purchases by other consumers of a particular product for which a discount has been offered). A token that changes state in this manner is sometimes described herein as an evolvable token. For example, the token may evolve based on consumer or merchant user interactions (e.g., a merchant request) with the token processing system.

There is a large variety of ways in which such a token may evolve. For example, the token may be a coupon with a discount for a product that changes based on current economic conditions or the remaining inventory of a merchant that is selling the product referenced in the coupon. Other examples of evolvable tokens (some for which the transactional token has an attribute of a coupon) include the following: depreciating or appreciating coupons; user ability to combine its various user coupons to generate new coupons; user ability to combine coupons of other users to create new coupons (e.g., by transfer of tokens from several users to a single recipient user); transactional tokens that grow in a game-like fashion to have new attributes and value; allowing users to share and transfer tokens amongst themselves; providing detailed reports to users or others on usage of tokens; and providing special loyalty rewards to frequent coupon users.

In another example, a user's token usage is tracked so that the user may accumulate a digital trophy collection (e.g., a set of electronic transactional tokens each having an attribute of a trophy). Also, tracking of this token usage enables coupons that change state based on the user's holding or acquiring other coupons, or based on the user's prior coupon usage.

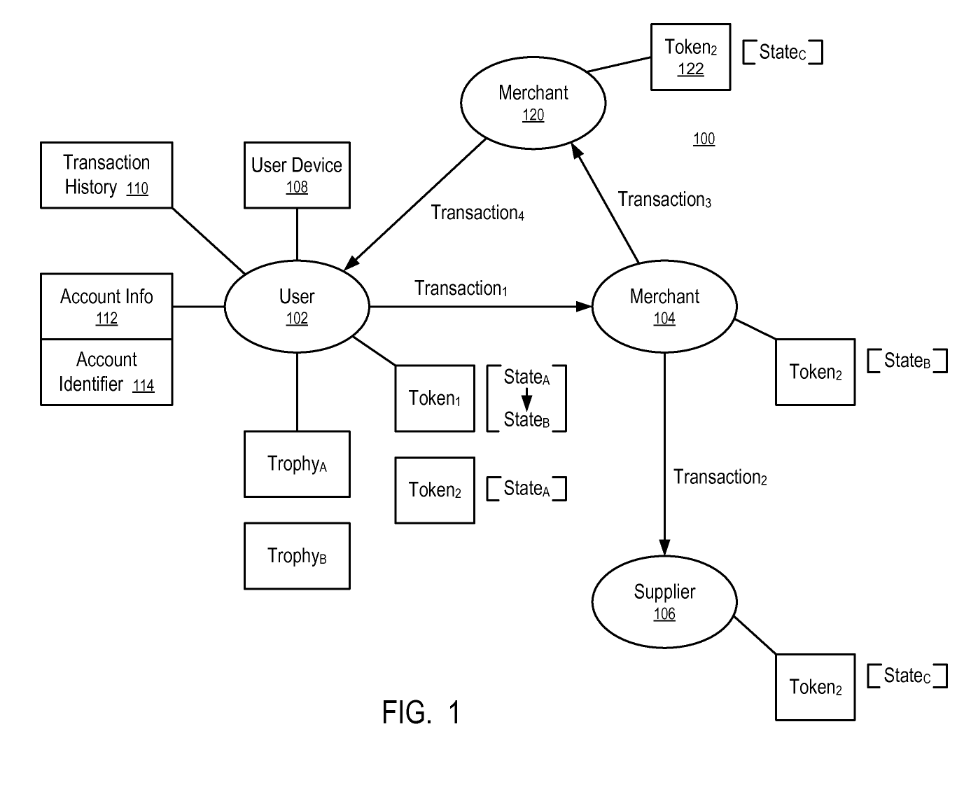

FIG. 1 illustrates a transactional flow 100 involving multiple transactions (Transaction₁ and Transaction₂) and entities (user 102, merchant 104, and supplier 106) according to one embodiment. Here, user 102 may possess one or more transactional tokens (e.g., that were previously generated and that are managed by a token processing system as discussed below). Examples of such tokens may include Token₁ and Token₂ (e.g., each token may provide a percentage discount on a purchase). Token₁ has a first state (State_{A}) prior to being applied or used in Transaction₁. After being applied to Transaction₁, Token₁ changes to a second state (State_{B}), for example as updated in a memory of the token processing system.

User 102 may own or otherwise be associated with a user device 108 (e.g., a mobile device). User device 108 may store information (e.g., a unique identifier that identifies the tokens that the user 102 possesses). A transaction history 110 is associated with user 102 and its prior purchase history. Transaction history 110 may be stored in a memory of user device 108 and/or in a memory of the token processing system (or alternatively stored on yet another computing device or server).

Account information 112 is associated with user 102. Account information 112 may be, for example, information regarding a credit card or debit card account of the user, and account information 112 may be originally generated by an issuer. This credit or debit card may be used to make purchases in Transaction₁ and/or Transaction₂. Processing of a transaction using this credit or debit card may be handled by a transaction handler.

Account information 112 may be uniquely associated with user 102 by an account identifier 114 that is part of account information 112. Account information 112 may be stored on one or more of the following: user device 108, a computing device of the issuer, a computing device of a transaction handler, and the token processing system discussed herein.

In one embodiment, merchant 104 originally requests the generation of Token₁ as a user of the token processing system (e.g., via logging on electronically by a user terminal or device). User 102 may have acquired Token₁ as part of a marketing promotion (electronic or non-electronic) by merchant 104, in which a discount on purchase of a good was advertised. Transaction₁ may be, for example, for the purchase of a good from merchant 104. User 102 may apply Token₁ to obtain a discount on this purchase, and may make the purchase using a credit card or other payment card. The purchase may be processed by a transaction handler that passes the associated transaction data to the token processing system. The application of the Token₁ to the transaction may be implemented by providing the unique identifier of Token₁ to the transaction handler, which may communicate with the token processing system. The transaction handler applies a discount to the purchase so that the user gets the benefit of the application of Token₁.

After Transaction₁ is completed, user 102 retains possession of Token₁, but Token₁ no longer has the attribute of providing a discount for any further purchase. This is reflected and implemented by changing the state of Token₁ to a new state, State_{B}, which is a post-purchasing state for which no discount is provided to the user. User device 108 and the token processing system may be updated to reflect this new state of Token₁. Also, the transaction data from Transaction₁ may be sent to the token processing system to update a transaction history that is maintained for Token₁ (along with other tokens of user 102), as discussed further below.

In one embodiment, from the perspective of user 102, Token₁ will be the same token after Transaction₁, as discussed above, and have the same unique identifier following the transaction. However, from the perspective of the token processing system, there will be two unique identifiers. The first unique identifier is the parent identifier (ID), which does not change. This may be, for example, the parent ID assigned to the initial Token₁ (e.g., assigned at generation of the token).

The second unique identifier links to the first unique ID and represents the current state of Token₁ (e.g., State_{A} or State_{B}). As Token₁ changes state, a new transactional token (having the second unique ID) is generated and is linked back to the first unique ID (i.e., the parent ID). In this manner, a full history of the token's evolution (e.g., through multiple transactions or other network events) can be stored in a memory of the token processing system.

Although State_{B} of Token₁ provides no further discount, in some embodiments, the user is provided a trophy that reflects the completion of the purchase by user 102 in Transaction₁. The collection of various trophies by user 102 may be desirable for user 102 for entertainment or other personal reasons, and further may be used to reflect or record progress towards completion or vesting of a new benefit for user 102 that may be applied to future transactions. This benefit may be a financial or other commercial benefit (e.g., a user may collect 10 trophies and then exchange these trophies for a new transactional token, according to rules handled by the token processing system).

In one embodiment, user 102 may collect trophies in various ways, all as managed by the token processing system. For example, the trophies may be implemented as transactional tokens having the attribute or state of being a trophy, but without having any attribute that provides a discount or other benefit in a future transaction. However, a trophy may have an attribute such that the collection of two or more trophies does provide a transactional benefit as managed by the token processing system, or that the trophies may be exchanged for a transactional token that has the attribute of a coupon for a future purchase.

Examples of trophies held by user 102 are Trophy_{A} and Trophy_{B}. Token₁ in State_{B} above was described as being in the state of a trophy. In an alternative embodiment, after completion of Transaction₁, user 102 may be provided with Trophy_{A} rather than retain Token₁ (in this case Token₁ may simply expire). Alternatively, user 102 may acquire Trophy_{A} in addition to retaining Token₁ in State_{B}. Trophy_{B} may, for example, have been provided to user 102 via a transfer from another user (e.g., a friend or a person in a social network of user 102, as defined on a social network website or server) of the token processing system.

In an alternative embodiment (using a cascading approach), rather than staying with user 102 after a transaction is completed, a transactional token may transfer (e.g., automatically via action of the token processing system upon receiving transaction data) from user 102 to merchant 104. In such a cascading system, a Token₂ is transferred to merchant 104 after the Transaction₁, and merchant 104 is then holding Token₂. The possession of Token₂ by merchant 104 will be updated in a memory of the token processing system. The transfer of tokens from one user to another user may be used in various embodiments related to usage of transactional tokens in a local region or network, as discussed further below.

Prior to Transaction₁, Token₂ has a State_{A} (e.g., similar to that as discussed above with respect to Tokenₛ). After Transaction₁, the state of Token₂ is changed to that of providing a discount for a future transaction (e.g., Transaction₂) by merchant 104 (e.g., this state is a new state, State_{B}, as illustrated). In this cascading system, user 102 may also get a trophy (e.g., Trophy_{B}), but the trophy is a new transactional token (having the attribute of a trophy) generated by the token processing system (a new token must be generated since user 102 no longer holds the Token₂).

Token₂ in State_{B} may, for example, provide merchant 104 with a discount for a purchase from supplier 106. After Transaction₂ is completed (e.g., with transaction processing and data handling similarly handled as discussed above for Transaction₁), Token₂ is transferred to supplier 106 and has a new state, State_{C}, that may provide a transactional benefit to supplier 106 for a future transaction. After each transaction, the token processing system updates a memory to reflect the entity that is currently possessing Token₂. The cascading process described above may be repeated for yet further transactions with other new entities and/or entities that were previously in the transactional flow 100.

### Token System

As was discussed above, a token processing system may generate transactional tokens and associate each token with one or more users. The system may monitor usage of the tokens in one or more transactions by the users (e.g., user 102 and merchant 104). In response to data received from this monitoring, the system may update a given token from a first state (e.g., State_{A} of Token₁ or Token₂) to a second state (e.g., State_{B} of Token₁ or Token₂).

Various embodiments of this token processing system are now here discussed. In a first embodiment, the monitoring includes receiving transaction data from a first transaction (e.g., Transaction₁) of a first user (e.g., user 102), the first token being applied to the first transaction. In another embodiment, this first transaction is between the first user and a second user (e.g., merchant 104), and the method further comprises responsive to applying the first token to the first transaction, transferring the first token to the second user. The second state corresponds to a transactional benefit for a future transaction of the second user.

In one embodiment, the transactions are for one or more purchases from a merchant by users other than the first user (e.g., users in a social network or other defined network or group including the first user), the first state corresponds to a discount for a future purchase of the first user, and the second state corresponds to a change in the discount for the future purchase, the change corresponding to the purchases by these other users (e.g., the change may be an increase in the discount based on a dollar amount of purchases being below a predetermined or targeted threshold). In another embodiment, the purchases may be by persons that are not users of the token processing system.

In one embodiment, the first state corresponds to a discount for a purchase from a first merchant (e.g., merchant 104), and the second state corresponds to a discount for a purchase from a second merchant (e.g., supplier 106).

In one embodiment, the first token comprises a plurality of attributes including a first attribute, and when the first token is in the second state, the first attribute provides a percentage reduction in price for a future transaction of the first user. Also, the method further comprises sending data regarding the second state to a mobile device (e.g., user device 108) of the first user.

In one embodiment, the first token comprises a plurality of attributes including a first attribute representing a trophy (e.g., an attribute of Trophy_{A} or of Token₁ in State_{B}), and the method further comprises, responsive to the first user collecting a predetermined number of trophies including the trophy, awarding a transactional token to the first user (e.g., a new token is generated and associated with the first user).

In one embodiment, the method further comprises associating a respective transaction history with each of the transactional tokens (e.g., this history may be stored in a memory accessible by the token processing system), and updating the respective transaction history based on transactions to which the respective token has been applied.

In one embodiment, the method further comprises, responsive to receiving a request from a merchant, updating the first token to a different state (e.g., the merchant may log in to the token processing system as a user to change the state of the token to correspond to different set of rules for obtaining a transactional benefit from application of the token to a transaction). In another embodiment, the method further comprises, responsive to receiving a request from a second user, updating the first token to a different state (e.g., a second user may log into the token processing system and provide input or a request to change the state of the first token).

In one embodiment, the users include a second user, the method further comprising responsive to receiving a request from the first user, transferring the first token to the second user. For example, user 102 may transfer its Token₁ and/or Trophy_{A} to another user of the token processing system. In one embodiment, the method further comprises adding an attribute to the first token based on a history of prior transactions of the first user.

In one embodiment, the method further comprises defining a network (e.g., an online grouping of user devices, user accounts, or other objects or sources of data that are treated as a group or class), and associating the transactional tokens with the network. In another embodiment, the method further comprises associating a number of user devices with the network, and receiving transaction data from the user devices for transactions to which the transactional tokens are applied.

In one embodiment, the monitoring of the usage of the tokens further includes, responsive to receiving transaction data for two or more users of the plurality of users other than the first user, updating the first token to a different state based on purchases of the two or more users. For example, transaction data received from the purchases by a group of users (e.g., a two-level deep social network of the user that is associated with the token processing system) may be analyzed and used to change the percentage discount offered in a transactional token.

In one embodiment, the method further comprises collecting data associated with the users, correlating the data to identify a new transactional opportunity (e.g., identifying a product of expected purchasing interest for a target group of persons or entities), generating new transactional tokens each providing a transactional benefit for the new transactional opportunity, and sending the new transactional tokens to new users and/or to a target group of persons or entities.

In one embodiment, the receiving of the transaction data by the token processing system includes receiving the transaction data by a transaction handler configured to receive from acquirer processors authorization requests for payments to be made by issuer processors according to account identifiers of users, the issuer processors to make the payments on behalf of users, and the acquirer processors to receive the payments on behalf of merchants.

### Token Processing System

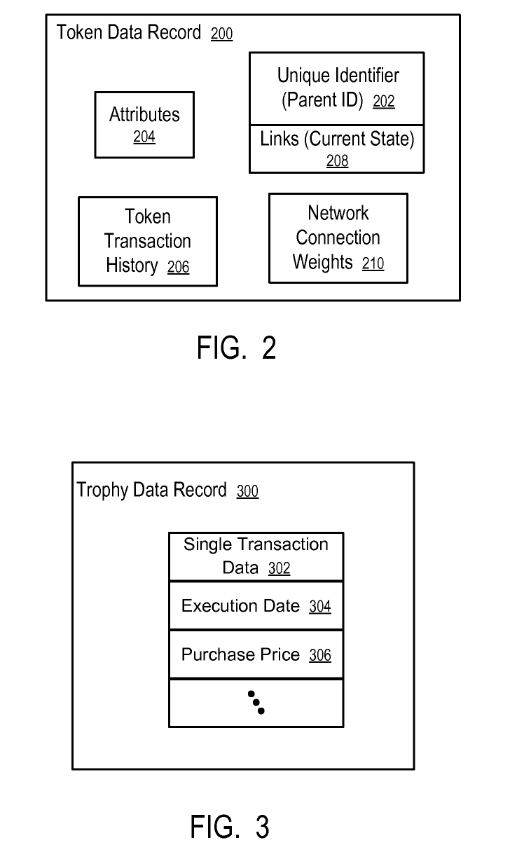

FIG. 2 illustrates token data record 200 according to one embodiment. As mentioned above, the token processing system may maintain data regarding various attributes 204 for each transactional token. For example, one attribute may be a discount to be applied to a purchase. A different attribute may be a trophy or a loyalty reward point allocation. As a token is used, transaction data associated with its use may be stored as token transaction history 206, which may be stored in a memory or database.

Token data record 200 includes unique identifier 202 (i.e., the first unique identifier or parent ID created and associated with the token when it is first generated). Second and subsequent unique identifiers or links 208 that are linked to the parent ID, as discussed above, are used to define the current state of the token. Each link 208 points to a definition of the current state and its attributes 204.

As mentioned above, a token may be associated with one or more networks. Token data record 200 may include network connection weights 210 to indicate the strength of association or connection of this particular token with a given one or more of these networks.

In one embodiment, networks may be further organized into network groups for analysis (e.g., of transactions of persons in the network group). A network group is a well-defined or abstract grouping of several networks. This grouping defines a higher order structure to the networks. An example of a network group is the set of all people using a social website, and a network within that group is a set of all people directly connected to a particular person in that social website. The connection between a network and a network group also can indicate strength, which may be stored as one of network connection weights 210.

FIG. 3 illustrates a trophy data record 300 according to one embodiment. Data record 300 provides data and history for prior purchases associated with a uniquely identified trophy (e.g., Token₁ in State_{B}, or Trophy_{B}, each as discussed above). This data may include transaction data 302 for a single purchase (e.g., Transactionₛ) that led to the existence of the trophy. This data may include the execution date 304 of the transaction and the purchase price 306 for the good or service purchased. In one embodiment, trophy data record 300 is incorporated into token data record 200.

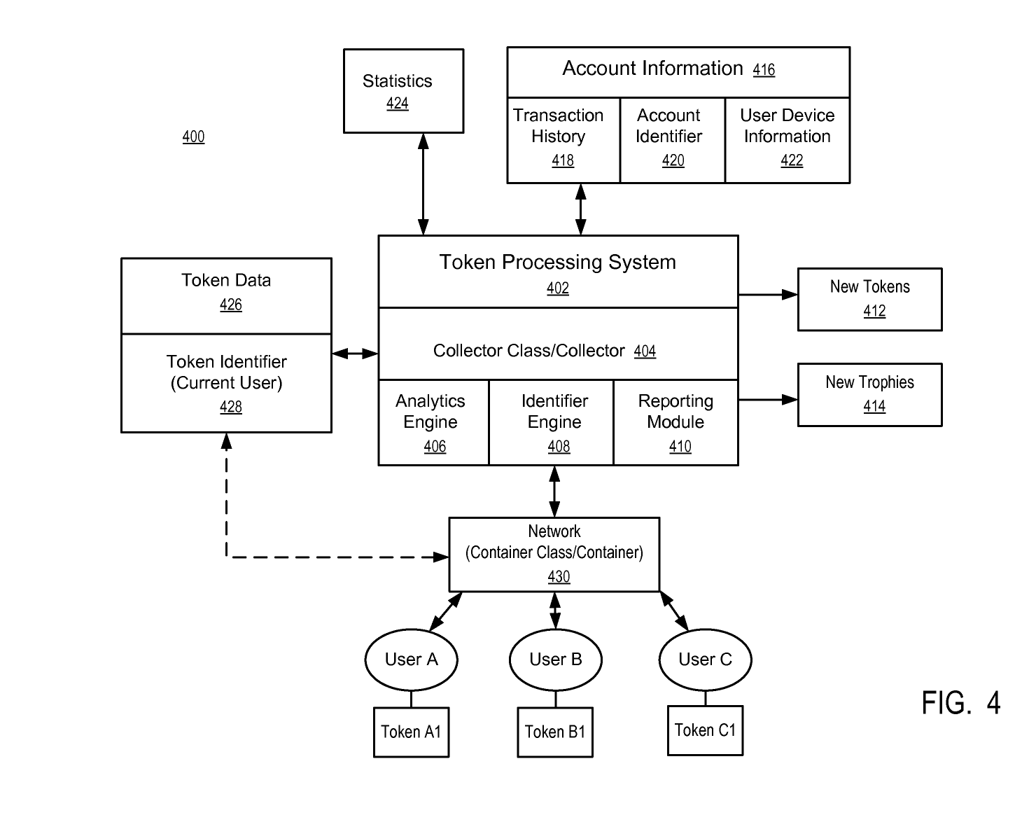

FIG. 4 illustrates a token processing infrastructure 400 according to one embodiment, including a token processing system 402, suitable for implementing the systems and methods discussed above. Token processing system 402 generates new tokens 412 and new trophies 414. Data for new and existing tokens (e.g., Tokens A1, B1, and C1) is stored as token data 426, and each token is assigned a token identifier 428, which is associated with a current user (e.g., User A, B, or C, etc.). As a token may be transferred by a user or due to some other action or event, the current user of the token is updated in token data 426. Token identifier 428 may be generated, for example, as a hash of data (e.g., account number, etc.) associated with a user. Other methods may be used.

As discussed above, each of the tokens managed by token processing system 402 may be associated with a network 430 (or alternatively network group). These associations may be stored as part of token data 426.

In one embodiment, networks are a container for the tokens (a network is sometimes referred to herein as a container class or a container). Networks can be defined abstractly (e.g., people who are likely to buy shoes in the next month) or physical (e.g., all devices that share a certain IP address). The connection or association between a network and a token has a weight (e.g., one of network connection weights 210). This weight may indicate a strength of the relationship. For example, the connection weight between tokens and networks could indicate a degree of association, affiliation, or social unity or community, or a probability that the relationship is valid, or a propensity towards the behavior used as a basis for defining the network. For example, a value of one indicates a direct match to the network. The foregoing may be generally described in that networks are containers for data objects associated with a set of tokens. In some cases, a network may be viewed as a container that links multiple tokens (i.e., the tokens are associated with the container).

In one embodiment, token processing system 402 includes a collector class and a number of collectors 404. The collector is a process that creates tokens (e.g., tokens 412) and networks (e.g., network 430) using predefined rules and functions. The collector may be implemented as an adaptable engine that populates the entities, defines the network relationships, defines how tokens are to evolve (change state), and controls how tokens interact with data and or events received from or associated with the network.

The collector class is the generic definition, while a specific collector (e.g., a home address collector) is specific to a certain data source (e.g., a social networking website). These collectors are XML configurable and hold the meta data definitions, models and data integrity rules.

A collector class may be a scoring model that builds statistical relationships between entities and networks and/or or creates direct connections (e.g., a connection between a person and a home address). One or more of a variety of known scoring models may be used to build these relationships. In general, the collectors build the data objects. A collector group is a higher order definition of collectors such as, for example, a group of social websites versus a single, particular social website.

Statistics 424 are stored in a memory or data store accessible to token processing system 402. Statistics 424 includes data used to build the statistical relationships (e.g., this data may be collected from user devices of users during transactions, or from third-party data sources such as demographic, business, or financial data). These relationships may be built in either real-time as transactions occur and/or in a batch mode. In one embodiment, both real-time and batch processing is done.

Account information 416 may be maintained in a data store (accessible to token processing system 402) and includes user data (e.g., account information 112). Account information 416 includes an account identifier 420 for each user, transaction history 418 for storing data from prior transactions (e.g., both for transactions to which tokens are applied and for other transactions), and user device information 422 to associate each user with a physical device of that user (e.g., a payment card or mobile device used by the user in a transaction). Token processing system 402 also includes analytics engine 406, identifier engine 408, and reporting module 410.

### Token System Implementations

Various exemplary implementations and variations are now discussed below. These implementations are not to be interpreted as limiting the generality of the foregoing systems and methods.

In one example, an electronic or digital coupon is implemented as a transactional token that builds complex networks. The coupon evolves in an interconnected environment having a large number of devices connected to a common network (i.e., devices associated with a defined network or network group). This evolvable token starts with a 30% discount, then changes state to provide a benefit when used with particular type or provider of a web service, and then changes state again to yet some other benefit for the holder of the token. The token has a unique ID that is associated after processing with a container group (the ID associates the token with the container group and the token processing system stores this association).

In another example, a trophy has a different value depending on what person or merchant the trophy is currently associated with (i.e., the trophy changes state to have different attributes or benefits as it is transferred from one entity to another). The trophy has a different value depending on the person or entity that is holding the trophy.

In one example, the token processing system may use statistics and transaction data to determine persons that have not yet purchased a good or service. The value of a token in possession of such a person is increased relative to a person who frequently makes purchases from the same merchant.

In one example, a traditional coupon (which is a form of external token not yet entered into the system) may be entered into the token processing system and handled as a new token within the system. For example, the coupon may have an identifying bar code or square that may be scanned (e.g., using a mobile device camera) and used to obtain data needed to build the new token. Each such traditional coupon will have a unique identifier when generated (e.g., coupons typically have an ID numbering associated with them, for example, when they are provided in magazines).

For example, the above coupon may be entered into a user network that is associated with an iPhone or iPad mobile device. The coupon is associated with this network and is also associated with an ID for this mobile device. The mobile device ID may be referenced to a specific user or group of users of the mobile device (e.g., this reference may be stored in user device information 422).

In another example, data and statistics are carried along with a token as it moves from one person to another. The data and statistics may be stored as part of token transaction history 206.

In another example, a user of a mobile device may scan a coupon from a website. The coupon is associated with a transactional token managed by token processing system 402. The user then applies the token to a transaction at the merchant location associated with the coupon offer (e.g., 30% off at the merchant). The merchant can scan the coupon/token in at the point of sale. Token processing system 402 then changes the state of the token from a coupon into what was described above as a trophy. The trophy data stores when and where the user executed the coupon.

The trophy connotes a sense of recognition that an event has occurred (e.g., a purchase or other event such as here where the coupon was redeemed). The trophy stores transaction and other data associated with a redemption. Once the user is in possession of the token that was applied, this data stays with the token for as long as the user is in possession of the token. The token may continue to remain associated with either the particular mobile device used in the transaction or other event, or remain with the user (e.g., as may be stored in token data 426).

In another example, if a user redeems coupons in order to accumulate a predetermined number of trophies, then the collection of trophies can generate another new token/coupon (e.g., by the user exchanging the trophies for a new token 412). Alternatively, the trophies could be exchanged for some other business or consumer offer, or could enable the user to access a new section of a website (e.g., a premium section with more privileges; or an access token for a website).

These trophies also may be used to interface with social websites such as the Facebook website and/or other websites, or they could be used to implement an access method if the user has a certain number of tokens. The trophies and tokens are configurable in numerous ways (one coupon or token may generate another coupon, or it could turn into another coupon).

In one example, an ID for a new token is generated by hashing various pieces of data together such as the time of day, the user, the device, etc. to create the ID (e.g., a twenty byte hash).

In one example, when a token is used on a particular user device, the token is associated with that device. The device itself is part of a network, and so the token is then associated with that network. The user of the device or the device itself may be associated (e.g., via statistics 424 or account information 416) with an IP address and/or to a physical address, so that this data also may be associated with the network.

The foregoing and other various types of data associated with the network (e.g., email addresses and/or zip codes of users in the network) provide data inputs (e.g., transaction data of the user and other users in the network) to collector 404, which analyzes the data and makes changes to the state of tokens (either tokens now being generated or existing tokens) to reflect the business situation and conditions as inferred from the analyzed data (this collector may also point to other tokens such as the user's device token, or to the user's account number, or to the user's transaction history). This process sets up a closed data feedback loop in which tokens affect transactions, and data from the transactions and/or the users associated with the transactions affects the state of tokens (new and existing) as reflected by their various attributes (e.g., a real-time change by a merchant in the amount of discount for a purchase that is associated with all tokens in a given network).

In another example of a business loop using tokens, someone other than the user may use a token/coupon. For example, the user may be a member of a social group (e.g., club). When the other member uses the token, the user receives a newly-generated coupon based on usage of the token by the other member (or members). The social group may already be part of a previously-defined network and/or a new network may be defined that includes the social group and its users.

In another example of a social group, a user is a member of a car club (e.g., there may be thousands of clubs in the United States). Each club may be associated with a network or container class, and each club may have members that possess tokens as described above. Tokens possessed by members of the car club generate data when applied or used, as discussed above. This data may be used by the token processing system (e.g., via an artificial intelligence engine) to infer or make correlations to data in other networks (e.g., for a different club). These inferences or correlations may be used as a basis for generating new tokens (e.g., for the different club).

In the example above, new tokens are sent to all members of the car club (e.g., sent to 200 user devices and 50 email addresses of the members). As the new tokens are used, token processing system 402 receives data. In one case, the new token is not actually generated until the email is read by the club member, and the club member clicks on an icon to indicate it wants to acquire the token/coupon. It is at that time that a token would be generated. Usage of the new tokens leads to generation of other new tokens based on analysis of the data.

As part of the analysis of this data, the token processing system sees that the new token is used by 100 people. A new network group is defined that includes these 100 people. This network group may be used for analysis by the token processing system. So, in one case, a top-level network includes all of the devices and all of the email addresses associated with the car club that use the same token. The intelligence engine analyzes this network and draws inferences that lead to the generation or creation of another type of token/coupon (e.g., it identifies a relationship between malt shop tokens and old car parts tokens).

Data from transactions or other usage of tokens involving or related to the social group may be correlated with other data in the token processing system. Various members of the social group may hold various types of tokens and trophies as were described above. The token processing system analyzes these holdings in deciding what new tokens to generate, and/or how to change the state of existing tokens (e.g., tokens in the network that includes the social group). For example, the rating of a token may be increased or decreased by this general process (and specific rules may define the specific increases or decreases to use).

In one example, the token processing system uses an artificial intelligence engine that is performing a variety of statistical and mathematic analysis. The engine has both batch and a real-time sides (e.g., the engine may be run on an entire population of users once a day, such as 100 million users). The outcome from the batch processing would determine the new coupons to be generated for the next day. The real-time generation of tokens would be based on transaction data as described above.

In one example, a transactional token points to multiple objects such as, for example, devices, consumers, and email addresses. The token may also further point to one or more networks or network groups. Thus, the token may be used as a basis for identifying a correlation between users in different networks or network groups.

### Token Usage in a Local Region or Network

As mentioned above, in some alternative embodiments, rather than staying with user 102 after a transaction is completed, a transactional token may transfer from user 102 to merchant 104. In one embodiment, Token₂ is transferred to merchant 104 after the Transaction₁, and merchant 104 then holds Token₂. The possession of Token₂ by merchant 104 will be updated in a memory of the token processing system. The transfer of tokens from one user to another user is used in this embodiment to provide transactional tokens that are restricted to use, or only have value when used, in a local region or network.

Referring again to FIG. 1, instead of Token₂ being transferred to supplier 106 as was discussed above, in this embodiment, Token₂ is transferred to a merchant 120. Token processing system 402 may store in a memory or database that user 102, merchant 104, and merchant 120 are all in a defined local region or network. The local region may be defined geographically such as by a list of street addresses, or zip codes, or city names, or may be defined by some distance from one or more geographic locations, or by other various means. Alternatively, a network may be defined, for example, as a set of users having a common network domain, users that are members of a common club or other organization (e.g., a social network defined at any of various levels of a social network or graph), or users that are in compliance with certain standards, regulations, or other criteria.

In one embodiment, a limited set of transactional tokens may be generated by token processing system 402. The number of tokens is controlled and usage of the tokens is limited to the local region or network. Thus, the tokens may have some of the characteristics of a local currency.

When the merchant 104 applies Token₂ to the Transaction₃, Token₂ is transferred to merchant 120 by token processing system 402. Token₂ as held by merchant 120 (i.e., token 122 in this embodiment) has a State_{C} that corresponds to a discount or other benefit for merchant 120 when token 122 is applied to a transaction with another entity in the local region or network (e.g., Transaction₄ with user 102). After Transaction₄, Token₂ is transferred to user 102. Thus, the transactional token (and its benefits) remains within the local region or network. In other embodiments, the tokens may be transferred to entities outside of the local region or network, but will not provide a transaction benefit until applied to a transaction with an entity in the local region or network.

In one embodiment, a method comprises: generating a plurality of transactional tokens including a first token; associating each of the transactional tokens with a respective one of a plurality of users, the first token associated with a first user of the plurality of users; monitoring usage of the transactional tokens in a plurality of transactions in a local region or network, the plurality of transactions including a first transaction of the first user; and in response to receiving transactional data regarding the first transaction, updating the first token from a first state to a second state.

In one embodiment, each of the plurality of transactional tokens is limited to transfer to an entity within the local region or network. In one embodiment, the first token is applied by the first user to the first transaction.

In one embodiment, the first transaction is between the first user and a second user, and the method further comprises responsive to applying the first token to the first transaction, transferring the first token to the second user. The second state corresponds to a transactional benefit for a future transaction of the second user. The transactional benefit for the future transaction requires usage of the first token in the local region or network.

In one embodiment, the generating the plurality of transactional tokens comprises generating a limited number of the tokens.

In one embodiment, the first state corresponds to a discount for a purchase from a first merchant, and the second state corresponds to a discount for a purchase from a second merchant. For example, the first merchant and the second merchant are both in the local region or network. In another example, discount is a fixed currency amount or a fixed percentage discount.

In one embodiment, the first token comprises a plurality of attributes including a first attribute, and in the second state the first attribute provides a percentage reduction in price for a future transaction of the first user. In one example, the method further comprises associating a respective transaction history with each of the transactional tokens, and updating the respective transaction history based on transactions to which the respective token has been applied (e.g., this history may include all transactions with entities in the local region or network). In one example, the plurality of users includes a second user in the local region or network, and the method further comprises responsive to receiving a request from the first user, transferring the first token to the second user.

In one embodiment, the tokens are limited to usage with a local network (it should be noted that the usage of the term “local network” does not imply a geographic limitation on the location of the users, but instead merely implies a defining of a particular set of users relative to their online or network presence or usage), and the method further comprises associating the transactional tokens with the network.

In one embodiment, the receiving the transactional data is received by a transaction handler configured to receive from acquirer processors authorization requests for payments to be made by issuer processors according to account identifiers of users, the issuer processors to make the payments on behalf of users, and the acquirer processors to receive the payments on behalf of merchants.

In one embodiment, a company operating a transaction handler (e.g., Visa or American Express) or other entity may issue or generate transactional tokens that provide discounts for participating merchants within a local region such as a city or county. These tokens may, for example, be acquired in various ways: accepting a local electronic coupon as a merchant, from a person-to-person transfer via a token processing system (e.g., a gift from one user to another user), or by merchant promotions. The supply of coupons may be limited to the number of transactions within a the local region. In one example, local regions or communities may issue company-branded cards (e.g., branded with a brand of the transaction handler and/or other entity) to promote use of such local coupons. In one approach, the transactional tokens may be applied or redeemed regardless of the actual payment method (e.g., the tokens or coupons can be used in conjunction with cash or another alternative payment method used to make a purchase). This local approach may permit local merchants and consumers to reduce the cost of producing goods locally. Also, in some cases, this local token approach may make it more difficult for a producer to falsely claim that its product is locally-produced when this is not true.

In other approaches, the usage of local tokens may be used to provide incentives for a desired behavior (e.g., use of a certain green technology) and provide the transactional benefits to entities (e.g., users) that conform with certain standards (e.g., associated with the usage of the green technology). The local region or network may be defined based on an entity's compliance with these standards (e.g., entities that comply are added as members of a defined network in token processing system 402).

The following sections below provide exemplary embodiments (e.g., a transaction handler and a transaction-data-based portal) that may be used in various implementations with the transactional token processing systems and methods described above, but the following sections do not limit the generality of these transactional token processing systems and methods. In some embodiments, the hardware described in the section titled “HARDWARE” below may be used to implement the systems and methods described above for the token processing infrastructure 400.

### Loyalty Network

Examples of the “card” include but not limited to credit cards, debit cards, bank cards, store-issued cards, prepaid cards, contactless cards, gift cards, or any conventional payment card or account that a customer can use in lieu of a cash or paper check payment, and these terms are used interchangeably herein.

Examples of “points” include but not limited to a loyalty award, promotion, reward, discount, rebate, sweepstakes entry, miles, instant-win award, product or service upgrade, or any conventional form of award given in exchange for card usage.

Examples of “cardholder” include but not limited to, for example, a user of any type of card or account discussed above.

Examples of “point-of-sale device” include but not limited to a transaction terminal.

Examples of “acquirer” include but not limited to the merchant's bank or financial institution.

Examples of “issuer” include but not limited to the issuer of the card of account discussed above, the cardholder's bank, or financial institution.

Examples of “transaction handler” include but not limited to an electronic payment system as well as any payment processing network and/or system for authorizing electronic payments and/or settling such payments between entities such as acquirers and issuers.

Examples of transactions processed by the transaction handler include transactions initiated by the cardholder physically presenting a credit card to a merchant for swiping or other data entry or providing credit card information to a merchant when the card is not physically present at the merchant's location, such as via a remote terminal, through use of a computer connected to the Internet, or over the telephone.

In one embodiment, a customer can use a card with any member of the group of merchants at a point-of-sale device. In return, the customer earns points in an awards program which can be redeemed at any of the currently participating merchants in the group.

An acquirer processor identifies the point-of-sale device and customer account information upon initiation of a purchase transaction. A payment authorization request is forwarded to a transaction handler. A promotion/award determination engine and associated database, are connected to the transaction handler. The engine is configured to determine when a customer is entitled to points, keep track of the points the customer accumulates over time, determine when the customer may redeem points, and subtract points from the total accumulated when the customer redeems them. Information regarding the status of points may be accessed via a web portal, mobile alert, email notification, or be forwarded from the promotion/award determination engine through the transaction handler to an issuer, and/or communicated to the merchant and customer/cardholder.

A number of merchants as a group may participate in an awards program. Member merchants may leave or join the group without impacting the validity of the point balances earned by the cardholders. The members may be associated in various ways. For example, the group may be geographically based, such as merchants within a particular zip code or area code. Or the group may be comprised of members who are independent business owners, members of a particular organization (e.g., the local chamber of commerce), have a certain numerical range of employees, or have revenue within particular limits.

The number of points that a cardholder can earn is based on the particulars of a purchase. So points may depend upon how much is purchased in a transaction or how much is purchased during a particular period of time.

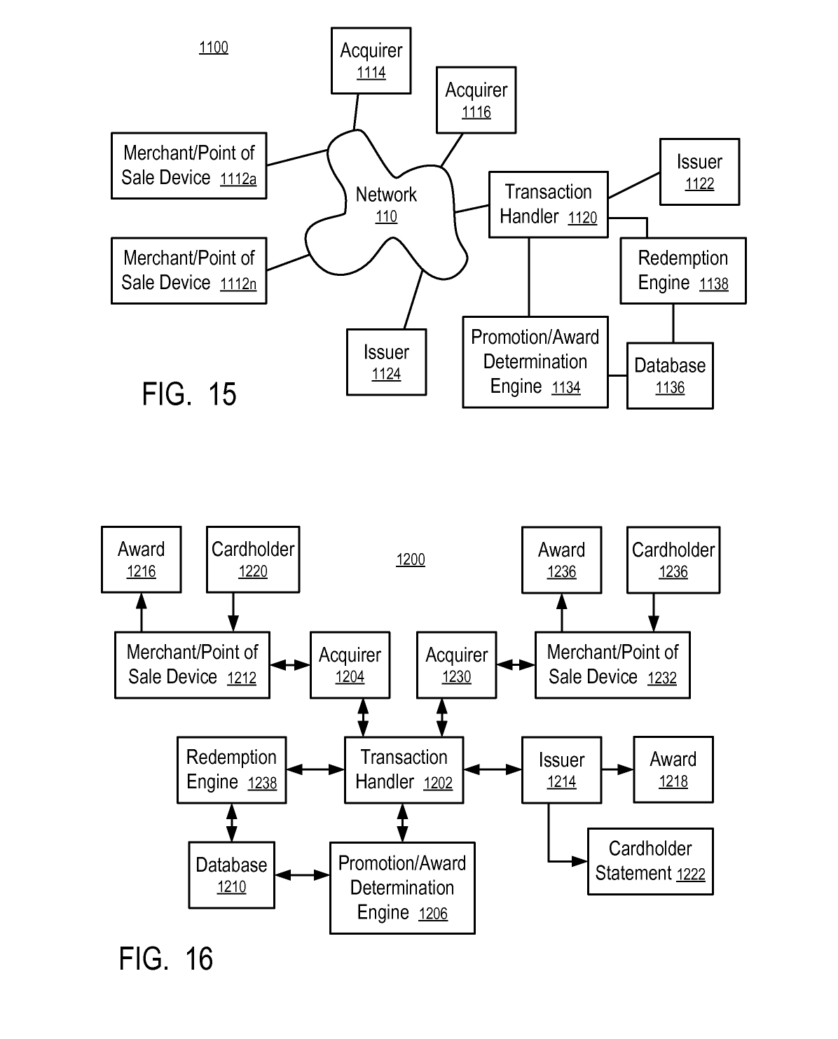

For example, upon making a purchase decision at a participating merchant, the cardholder presents a card and/or account identification information, to the merchant who processes it using a point-of-sale device. The point-of-sale device communicates merchant identification, a card number, and requested dollar amounts to an acquirer. Referring to system 1100, illustrated in FIG. 15, participating merchant point of sale devices 1112a and 1112n are connected to a data communication network 1110 and thereby to an acquirer processor such as one of acquirer processors 1114 and 1116.

In one embodiment, acquirer processors 1114 and 1116 are connected via the network 1110 to a transaction handler 1120 that couples to a promotion/award determination engine 1134.

In one embodiment, a promotion/award determination engine is in communication with an acquirer processor 1114, 1116, or an issuer 1122, 1124, bypassing the transaction handler 1120, when the network of participating merchants use the same acquirer.

In one embodiment, when cardholders are associated with the same issuer, a promotion/award determination engine can be connected to the issuer.

In one embodiment of FIG. 15 the promotion/award engine 1134 communicates with the issuer 1122, 1124 and acquirer 1114, 1116 through transaction handler 1120, to allow merchants of different acquirers to participate in the reward program and to allow cardholders of different issuers to benefit from the reward program.

The promotion/award determination engine 1134, employing database 1136, and with access to award rules, determines whether the customer is entitled to accumulate points or redeem points. The award rules determine whether the customer has to enroll in a reward program in order to obtain points. The engine 1134 determines if the merchant is within the current participating group in order for it to authorize awarding or redeeming points. A qualified transaction with a current participating merchant enrolled in the reward program can earn points. Upon making its determination of granting points in accordance with the award rules, the promotion/award determination engine 1134 updates its database to record the points granted to an account.

A redemption engine 1138 is coupled to the database 1136 and with access to redemption rules. The redemption rules determine whether a transaction is entitled to redeem points accumulated under the account number of the cardholder. The redemption engine 1138 processes the redemption request and the redemption amount, if any, and authorizes a discounted payment amount.

FIG. 16 illustrates a block diagram of a financial-transaction processing system 1200 including transaction handler 1202. The system 1200 includes a promotion/awards determination engine 1206, a redemption engine 1238, and a database 1210, in accordance with one embodiment. In one embodiment, the database stores the identity information of the current group of merchants enrolled to provide awards to customers for use within the group of merchants, and allow the awards to be redeemable at any member of the group. Merchant point-of-sale devices 1212 and 1232 are connected to acquirer processors 1204 and 1230 respectively. In turn, the acquirer processors 1204 and 1230 are connected to a transaction handler 1202 that may be comprised of one or more computers. The transaction handler 1202 is connected to at least one issuer 1214. Acquirer processors 1204 and 1230 forward information regarding a particular card transaction through the transaction handler 1202 to promotion/award determination engine 1206 and associated database 1210.

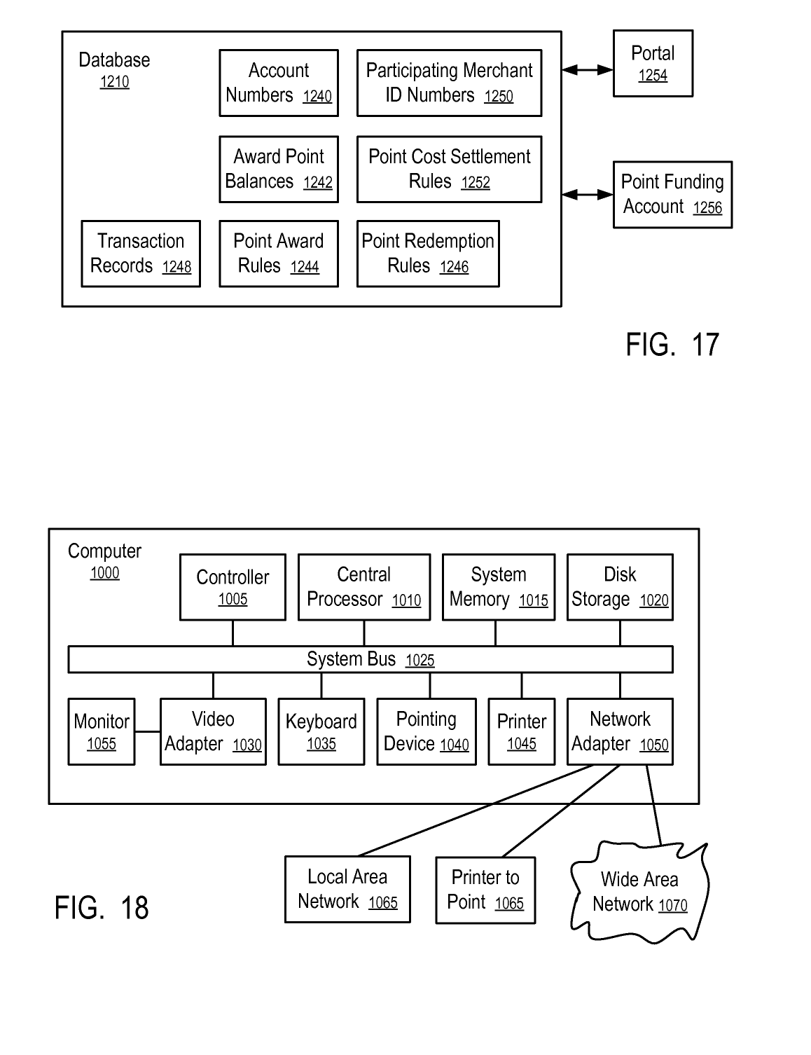

The promotion/award determination engine 1206 processes transaction data to determine award status. The engine 1206 accesses the data, including transaction records and award rules, from database 1210, shown, in one embodiment, in detail in FIG. 17. Stored data in database 1210 include cardholder account numbers 1240, reward point balance information 1242, point award rules 1244, point redemption rules 1246, transaction records 1248, a list of current participating merchants 1250, and point cost settlement rules 1252. In addition, database 1210 may connect to a portal 1254 and point funding account 1256.

From a record of a transaction passed to it via the transaction handler 1202, the engine 1206 compares a merchant identification number of the transaction against a list of identification numbers of participating merchants 1250 contained in database 1210 to determine if the transaction is entitled to points. If customer enrollment is required, it determines whether the cardholder is eligible for an award program sponsored by the group in one embodiment. The award rules may specify other criteria for a qualified transaction, such as the time of the transaction, the amount of the transaction, etc. Based on the information, and point awarding rules 1244, a cardholder's award point balance 1242 is updated by the engine 1206. Based on the point cost settlement rules 1252, the engine determines the price, if any, that the merchant or other sponsors pays for the points awarded in response to the current transaction.

Based on the point redemption rules, the cardholder may redeem part or all of the award point balance 1242. For example, using a web portal of the engine, the cardholder may view the point balance and request the redemption of an amount of points as a virtual gift card usable at one of the participating merchants. When the cardholder makes the qualified transaction, the amount of points is deducted from the account and the user is given a statement of credit for the redeemed amount and the merchant is paid with corresponding amount from the account (1256) funding the points.

In one embodiment, the redemption rules allow automated point redemption without user having to request via the portal. The redemption rule is based on transaction time, location, and/or amount. Point funding account 1256 is configured to hold the funds to finance the cost of points. In one embodiment, portal 1254 is coupled to the database for outside inquiries to obtain, for example, information regarding balances.

Information about the awards 1216 and 1234 is provided to cardholders 1220 and 1234 at the point-of-sale in real-time (e.g., via mobile alert, email notification, purchase receipt). The merchant 1212, 1232 may provide information about accumulated or redeemed points to the customer, or the issuer may provide this award information 1218 to the customer/cardholder in a statement 1222.

There are several ways, singly or in combination, to fund the loyalty program. In one embodiment, the program be “pre-funded” in which merchants pay for points as they are given to customers. When engine 1206 determines that an amount of points is to be awarded to the cardholder in response to a transaction, the transaction handler charges the merchant for the cost of the points (e.g., via the settlement of the transaction, which a portion of the amount paid by the issuer is deposited in the account 1256).

In an alternative embodiment the program is “post-funded” where merchants pay for points as they are redeemed. To support the post-funded model, the award information recorded for the account 1240 includes the list of points earned on a specific date from a specific merchant. In settling the point redemption transaction, the transaction handler charges the respective merchants that provided the points that are being redeemed to collect funds and provide the collected funds to the current merchant at which the points are used. In one embodiment, the transaction handler generates the secondary transactions to collect the funds in response to the transaction that uses the points.

In one embodiment, merchants in the group pay a monthly fee, pay based on performance with a discount for higher numbers and amounts of transactions, or pay through a barter system. The system may also be funded partly or entirely by the card company.

It is anticipated that group members may leave or join the group from time to time. Thus, rules 1244, 1246, 1252 are configured to cover this situation. For example, a cardholder may obtain some points from a first merchant and some points from a second merchant, who subsequently leaves the group. Then the cardholder may desire to redeem the points at a third merchant. According to one embodiment, the rules may require the second merchant to prepay for the points the second merchant awarded to the cardholder via the “pre-funded” model. Or, otherwise, the second merchant may pay for outstanding points upon leaving the group. In yet another embodiment, the third merchant pays for points upon redemption. In any event, the number of points in the cardholder's account, in many embodiments, is not affected by members joining or leaving the group.

Referring to FIG. 18, a system is shown which includes a digital processing apparatus. This system includes a computer 11000, which can be used to implement components of a customer loyalty system according to one embodiment, such as transaction handler 1120 acquirer processors 1114, 1116, issuer processors 1122, 1124, merchant point-of-sale devices 1112a, 1112n, and promotion/award determination engine 1134.

Transaction handler 1120 may comprise one or more computers configured to handle arriving transactions. Likewise, acquirer processors 1114, 1116, issuer processors 1122, 1124, merchant point-of-sale devices 1112a, 1112n, and promotion/award determination engine 1134 and respective database 1136 may comprise computers. A cardholder/customer may make purchases utilizing a computer such as a mobile device (e.g., laptop, notebook, tablet, mobile telephone, or PDA) or a desktop device.

The computer 1000 may include a graphics display, print hardware, and print software, may be as simple as a generic personal computer, desktop computer, laptop computer, or may be configured to perform transaction processing. The computer may be incorporated into a cellular telephone, personal digital assistant, tablet computer, network enabled television set, or any other internet connected device. The example computer in FIG. 17 includes central processor 1010, system memory 1015, optional data storage 1020 (e.g., hard drive, CD-ROM drive, non-volatile memory such as flash memory, or DVD drive), controller 1005, network adapter 1050, video adapter 1030, and monitor 1055. Data input may be through one or more of the following agencies: keyboard 1035, pointing device 1040, disk storage 1020, local area network 1060, point to point communications 1065, and wide area network 1070 (e.g., internet).

One or more features of the computer as shown may be omitted while still permitting the practice of various embodiments. For example, printer 1045 is not necessary for images to be displayed on monitor 1055. Any combination of monitor 1055, keyboard 1035, and pointing device 1040 may be omitted for a computer performing “back-office” work. Likewise, local area network 1060, point to point communications 1065, and wide area network 1070 singly or collectively may be employed.

### Loyalty Coalition

In one embodiment, a system and method is provided to extend the loyalty benefit redemption capability to point of sales (online or offline), provide a universal loyalty currency, and/or to enable exchange of loyalty benefits across different loyalty programs.

In one embodiment, the system allows an account holder to control the spending of the loyalty benefits. The system provides the account holder with choices in using the loyalty benefits earned in various loyalty programs and thus puts the spending power of loyalty reward benefits in the control of the account holder. The system expands the use and the flexibility of loyalty reward benefits and increases the account holder engagement with loyalty programs.

In one embodiment, the system provides incremental spend at merchants via the monetization of loyalty benefits as currency. The system provides benefits to merchants via increased brand affinity, repeated traffic, and increased transaction size. The system provides merchants with cooperative marketing opportunities.

In one embodiment, the system provides benefits to loyalty program providers via increased consumer affinity and program active rates, reduced program churn, increased aspiration value, improved cooperative marketing opportunities, and differentiated programs.

In one embodiment, a user (101) is provided with a user interface to register one or more loyalty reward programs as a method of payment in association with account information (142). After the registration, the user (101) can use the loyalty reward benefits accumulated in the one or more loyalty reward programs to pay for goods and services purchased from merchants, using the account information (142).

In one embodiment, the account information (142) is provided in a universal loyalty program device, as disclosed in U.S. patent application Ser. No. 13/432,249, filed Mar. 28, 2012, assigned U.S. Pat. App. Pub. No. 2012/0253914, and titled “Universal Loyalty Program Device”, the disclosure of which application is hereby incorporated herein by reference.

In one embodiment, the account information (142) is associated with the consumer account (146) hosted on the issuer processor (145). The consumer account (146) includes funds and/or credits controlled by the issuer processor (145) separated from the loyalty benefits provided by the loyalty program providers. The association of the loyalty programs with the consumer payment account (146) allows the use of loyalty benefits as a way to make payments with merchants who accept the consumer payment account (146) as a way to make payments. The loyalty benefits can be used with online merchants and offline merchants.

In one embodiment, the registration is performed via an online site. In one embodiment, the registration is performed via issuance of a new consumer account (146) and/or a new account identification device (141). In one embodiment, the registration is performed via a digital wallet. In one embodiment, the registration is performed at the Pointer of Sale, such as transaction terminals (105).

In one embodiment, the user (101) may identify the loyalty benefits as a currency for the payment initiated at the transaction terminal (105), in a way as disclosed in U.S. patent application Ser. No. 12/704,445, filed Feb. 11, 2010, entitled “Point of Interaction Loyalty Currency Redemption in a Transaction” and published as U.S. Pat. App. Pub. No. 2010/0211469. The payment transaction can be processed in a way disclosed in U.S. patent application Ser. No. 13/865,101, filed Apr. 17, 2013 and entitled “Systems and Methods to Use Transaction Authorization Communications to Process Offers”, or in a way disclosed in U.S. patent application Ser. No. 13/356,506, filed Jan. 23, 2012 and entitled “Systems and Methods to Facilitate Loyalty Reward Transactions” and published as U.S. Pat. App. Pub. No. 2012/0191525.

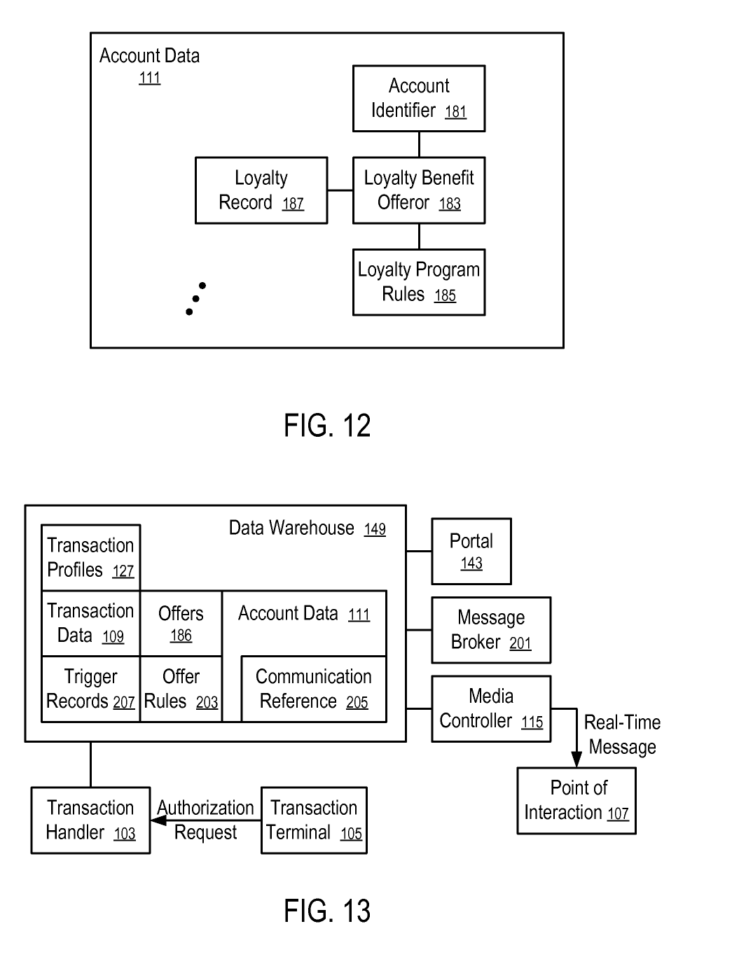

In one embodiment, the loyalty benefit is tracked in a centralized way in association with the account data (111) as illustrated in FIG. 12 and discussed in U.S. patent application Ser. No. 12/896,632, filed Oct. 1, 2010, entitled “Systems and Methods to Provide Loyalty Programs” and published as U.S. Pat. App. Pub. No. 2011/0087530.

In one embodiment, separate third party loyalty program providers may track the loyalty benefits for the loyalty programs in which the user (101) enrolls. In one embodiment, the user (101) may exchange the benefits from the third party loyalty program providers for the loyalty benefits hosted in the centralized data warehouse (149) for the account data (111) and/or exchange the loyalty benefits hosted in the data warehouse (149) for the account data (111) for the benefits with the third party loyalty program providers.

In one embodiment, the loyalty benefits hosted in the centralized data warehouse (149) can be earned from a plurality of participating merchants and be used as a way of payments with the participating merchants. In one embodiment, the merchants may dynamically join or leave the loyalty coalition, in a way as disclosed in U.S. patent application Ser. No. 13/543,369, filed Jul. 6, 2012 and entitled “Systems and Methods for Customer Loyalty Program.”

In one embodiment, the loyalty benefits are transferrable and exchangeable among users and between users and merchants, in a way as local value coupons/benefit tokens disclosed in U.S. patent application Ser. No. 13/485,645, filed May 31, 2012 and entitled “Local Usage of Electronic Tokens in a Transaction Processing System” and published as U.S. Pat. App. Pub. No. 2012/0310838.

In one embodiment, the user (101) may register a loyalty account via the portal (143) to convert the loyalty benefits accumulated in the loyalty account into a benefit associated with the account data (111) and/or the account information (142). In one embodiment, the loyalty benefits accumulated in the loyalty account is converted into loyalty benefits provided by the transaction handler (103).

In one embodiment, the loyalty benefit conversion is performed in response to a user request received in the portal (143). In one embodiment, the loyalty benefit conversion is performed in an automated way based on a set of predefined preferences, such as a threshold, a monthly conversion date, etc. For example, in one embodiment, the third party loyalty benefits are converted into the loyalty benefits provided by the transaction handler (103) and hosted in the data warehouse (149), when the amount of the third party loyalty benefits accumulated with the third party loyalty program provider is above a threshold. For example, in one embodiment, the third party loyalty benefits accumulated with the third party loyalty program provider is converted to the loyalty benefits provided by the transaction handler (103) and hosted in the data warehouse (149) periodically (e.g., daily, weekly, monthly, semi-annually, annually). In one embodiment, the loyalty benefit conversion is performed at the time for the authorization of the use of the loyalty benefit.

In one embodiment, the loyalty benefits provided by the transaction handler are recorded in the account data (111) using an independent loyalty currency that is not fixedly associated with a government issued currency. For example, the loyalty benefits may be measured in terms of points or miles, which may or may not have a fixed exchange ratio with respect to U.S. dollar. For example, different third party loyalty benefits may be backed by different currencies issued by different governments; and the exchange rate among the currencies issued by different governments may cause changes in the exchange ratio between the loyalty benefits provided by the transaction handler and a currency issued by a government (e.g., U.S. dollar).

In one embodiment, the loyalty benefits for the account data (111) is backed by a predetermined currency issued by a government. When the loyalty benefits are transferred from the third party loyalty program provider to the transaction handler (103), the currency backed the third party loyalty benefit is exchanged to the predetermined currency according to the exchange rate the time of the transfer.

In one embodiment, the loyalty benefits may be transferred from the third party loyalty program to the transaction handler (103) without changing the currency used to back the loyalty benefits. When loyalty benefits backed by different currencies are transferred to the transaction handler (103), the actually funds backing the loyalty benefits may involve funds in terms of these different currencies.

In one embodiment, the exchange ratio between the loyalty benefits provided by the transaction handler (103) is based on the loyalty benefits awarded to the users (e.g., 101) and funds in different currencies collected to back the loyalty benefits. Alternatively, currency exchange is performed at the time the loyalty benefits are transferred to the transaction handler (103) to back the loyalty benefits hosted on the transaction handler (103) using a same currency issued by a government.

In one embodiment, the funds to back the loyalty benefits are collected at the time the loyalty benefits are awarded to the user (101) (e.g., via the third party loyalty program providers and/or the centralized loyalty program hosted on the data warehouse of the transaction handler (103)).

In one embodiment, the specific benefits awarded to the user (101) is tracked via a digital token as disclosed in U.S. patent application Ser. No. 13/485,645, filed May 31, 2012 and entitled “Local Usage of Electronic Tokens in a Transaction Processing System” and published as U.S. Pat. App. Pub. No. 2012/0310838. In one embodiment, the token identifies not only the amount benefit in terms of a loyalty currency (e.g., points or miles), but also the currencies and currency amounts that are collected to cover the cost of the loyalty benefits.

In one embodiment, the costs to provide the loyalty benefits are collected at the time the loyalty benefits are used by the user (101) as a payment in purchasing products and/or services from a merchant.

In one embodiment, after the user (101) has an amount of loyalty benefits that are hosted on the data warehouse (149), the user (101) may conduct a transaction either online or offline at a merchant and pay for the goods and/or services like a regular transaction made using a financial account (e.g., a credit card account, a debit card account, a prepaid card account) supported by the transaction handler (103). In one embodiment, the transaction terminal (105), the user (101) can select a redemption parameter to identify the amount of loyalty benefits to be redeemed from the data warehouse (149) for application to the payment.

In one embodiment, the merchant is reimbursed for the loyalty benefits provided to the user via a credit transaction using funds collected to back the loyalty benefits; and if the amount of the redeemed loyalty benefits is lower than the purchase price for the transaction, the difference between the purchase price and the redeemed amount is charged to the consumer account (146) identified by the account information.

In one embodiment, the consumer account (146) is charged the purchase price for the merchant; and the redeemed loyalty benefits are provided to the user via statement credits to the consumer account (146).

In one embodiment, the costs of the loyalty benefits are collected at the time of settlement of the transactions that use the loyalty benefits. In one embodiment, the loyalty benefits hosted on the data warehouse (149) and provided by the transaction handler (103) are tracked via digital tokens that identify the providers of the loyalty benefits that were transferred the transaction handler (103). The settlement of the redeemed loyalty benefits are integrated with the settlement of the transaction initiated using the account identification device (141).

In one embodiment, when the redemption of the loyalty benefits is authorized in a transaction initiated using the account identification device (141), the message broker (201) generates a confirmation alert; and the media controller (115) transmits the confirmation alert to the point of interaction (107) of the user (101) using the communication reference (205) registered in the account data (111). In one embodiment, the confirmation alert is transmitted in real time and/or in parallel with the processing of the authorization request initiated on the transaction terminal (105).

In one embodiment, the merchants can manage offers for the redemption of the loyalty benefits. For example, in one embodiment, the merchants may specify different exchange rates of loyalty benefits and price discounts for products and/or services provided by the respective merchants. When a merchant specify a rate that is lower than the current exchange rate between the loyalty benefits and the currency backing the loyalty benefits, the merchant provides a discount to promote the products and/or services (since the merchant is reimbursed at a rate lower than the price discount provided by the merchant). The merchant may specify different rates for different products, services, and deals (e.g., combinations of products and/or services).

Similarly, in one embodiment, a merchant may manage offers for the awarding of loyalty benefits. For example, in one embodiment, the merchant may specify different rules for award loyalty benefits based on the purchases prices, the time and/or channel of the payment transaction for the purchase, and/or the identification of the products or services purchased. For example, the merchant may award loyalty benefits according to a first ratio based on the purchase price for first products purchased during a first period of time and according to a second ratio with respect to the purchase price for second products purchased during a second period of time.

In one embodiment, the merchants can describe and manage the offers in a way as disclosed in U.S. patent application Ser. No. 13/237,457, filed Sep. 20, 2011, entitled “Systems and Methods to Program Operations for Interaction With Users” and published as U.S. Pat. App. Pub. No. 2012/0078697. A merchant can modify the benefit award rates and discount redemption rates on the fly without having to restart the system.

In one embodiment, when a merchant is not offering a discount, the user (101) is still allowed to redeem the loyalty benefits to make the payment to the merchant. In such a scenario, the transaction handler (103) is configured to determine the exchange rate that matches the amount of loyalty benefits redeemed and funds to be reimbursed to merchant.

In one embodiment, one or more benefits brokers are used to convert the loyalty benefits from one loyalty program provider to the loyalty benefits of the transaction handler (103).

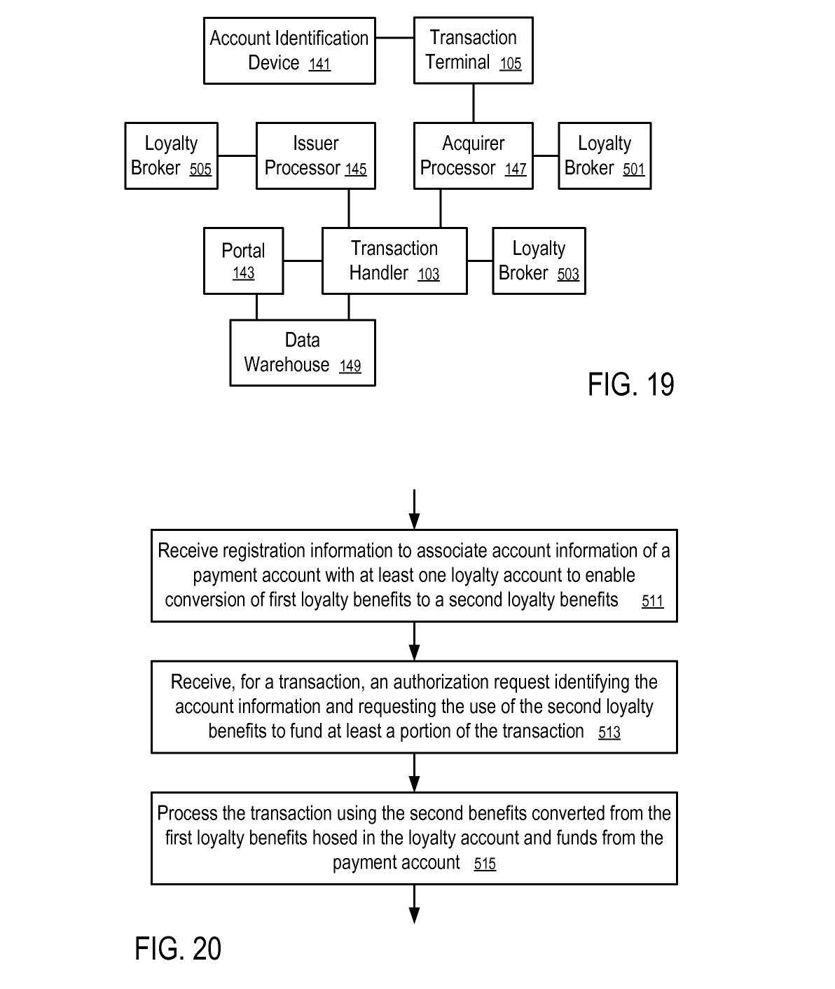

FIG. 19 illustrates a system configured to process loyalty benefits according to one embodiment. In FIG. 19, loyalty brokers (501, 503 and 505) are coupled with the acquirer processor (147), the issuer processor (145), and the transaction handler (103) respectively. In a transaction network, multiple issuer processors (e.g., 145) and multiple acquirer processors (147) may be coupled to the transaction handler (103). Some or all of the issuer processors (145) may be configured to be coupled with respective loyalty brokers (e.g., 505). Some or all of the acquirer processors (147) may be configured to be coupled with respective loyalty brokers (e.g., 501). In one embodiment, the issuer processors (145) may not have respective loyalty brokers (e.g., 505). In one embodiment, the acquirer processors (147) may not have respective loyalty brokers (e.g., 501).

In one embodiment, the transaction handler (103) is configured with a sole loyalty broker (503) in the system.

In one embodiment, the loyalty benefits to be awarded and/or redeemed are specified in the units of loyalty benefits provided by the transaction handler (103). When the actually loyalty to be redeemed is not hosted on the transaction handler (103), the loyalty brokers (e.g., 501, 503 and 505) are configured to hold and/or transfer the loyalty benefits.

For example, in response to an authorization request from the transaction terminal (105) that identifies the use of the consumer account (146) for the payment and a request for redemption of an amount of loyalty benefit from a loyalty account associated with the consumer account (146), the loyalty broker (503) is configured to request a hold on the redeemed points. During the settlement of the transaction, the loyalty broker (503) causes the conversion of the loyalty benefits hosted on the third party loyalty program providers to funds; and the transaction handler (103) instructs the respective fund processors to settle the cost of the loyalty benefit redemption.

In one embodiment, the third party loyalty program is provided via the issuer processor (145); and the loyalty broker (505) coupled with the issuer processor (145) is configured to perform the authorization of loyalty benefit redemption, holding authorized redemption of loyalty benefits, and/or settlement the redeemed loyalty benefits.

In one embodiment, the loyalty broker (501) is configured to perform loyalty transactions for the transaction terminals (e.g., 105) coupled with the acquirer processor (147).

In one embodiment, the loyalty brokers (e.g., 501, 503, 505) are also configured to convert loyalty benefits in response to the users earning loyalty benefits from the respective purchases.

FIG. 20 shows a method to redeem loyalty benefits according to one embodiment. In FIG. 20, a computing apparatus is configured to receive (511) registration information to associate account information of a payment account with at least one loyalty account to enable conversion of first loyalty benefits to a second loyalty benefits; receive (513), for a transaction, an authorization request identifying the account information and requesting the use of the second loyalty benefits to fund at least a portion of the transaction; and process (515) the transaction using the second benefits converted from the first loyalty benefits hosed in the loyalty account and funds from the payment account.

In one embodiment, the merchant specifies an offer that allows the user (101) to redeem the loyalty benefits for a discount that is higher than what is reimbursed to the merchant for the cost of the loyalty benefits and thus provide a net discount for accepting the loyalty benefits.

In one embodiment, the transaction handler is configured to reimburse the merchant for the discount applied to redeem the loyalty benefits and the reimbursement is equal to the discount. In one embodiment, the transaction handler is configured to change the consumer account the full transaction amount for the merchant and credit the consumer account for the redeemed amount of loyalty benefit. Thus, the merchant provides no net discount for accepting the loyalty benefits.

### Transaction Based Intelligence Information

Millions of transactions occur daily through the use of payment cards, such as credit cards, debit cards, prepaid cards, etc. Corresponding records of the transactions are recorded in databases for settlement and financial record keeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008 and entitled “Techniques for Targeted Offers.”

U.S. Pat. App. Pub. No. 2009/0216579, published on Aug. 27, 2009 and entitled “Tracking Online Advertising using Payment Services,” discloses a system in which a payment service identifies the activity of a user using a payment card as corresponding with an offer associated with an online advertisement presented to the user.

U.S. Pat. No. 6,298,330, issued on Oct. 2, 2001 and entitled “Communicating with a Computer Based on the Offline Purchase History of a Particular Consumer,” discloses a system in which a targeted advertisement is delivered to a computer in response to receiving an identifier, such as cookie, corresponding to the computer.

U.S. Pat. No. 7,035,855, issued on Apr. 25, 2006 and entitled “Process and System for Integrating Information from Disparate Databases for Purposes of Predicting Consumer Behavior,” discloses a system in which consumer transactional information is used for predicting consumer behavior.

U.S. Pat. No. 6,505,168, issued on Jan. 7, 2003 and entitled “System and Method for Gathering and Standardizing Customer Purchase Information for Target Marketing,” discloses a system in which categories and sub-categories are used to organize purchasing information by credit cards, debit cards, checks and the like. The customer purchase information is used to generate customer preference information for making targeted offers.

U.S. Pat. No. 7,444,658, issued on Oct. 28, 2008 and entitled “Method and System to Perform Content Targeting,” discloses a system in which advertisements are selected to be sent to users based on a user classification performed using credit card purchasing data.

U.S. Pat. App. Pub. No. 2005/0055275, published on Mar. 10, 2005 and entitled “System and Method for Analyzing Marketing Efforts,” discloses a system that evaluates the cause and effect of advertising and marketing programs using card transaction data.

U.S. Pat. App. Pub. No. 2008/0217397, published on Sep. 11, 2008 and entitled “Real-Time Awards Determinations,” discloses a system for facilitating transactions with real-time awards determinations for a cardholder, in which the award may be provided to the cardholder as a credit on the cardholder's statement.

In one embodiment, transaction data, such as records of transactions made via credit accounts, debit accounts, prepaid accounts, bank accounts, stored value accounts and the like, can be further processed to optionally provide information for various services, such as reporting, benchmarking, advertising, content or offer selection, customization, personalization, prioritization, etc. In one embodiment of improving privacy protections, users are required to enroll in a service program and provide consent to allow the system to use related transaction data and/or other data for the related services, and the system is configured to provide the services while protecting the privacy of the users in accordance with the enrollment agreement and user consent.

For example, based on the transaction data, an advertising network in one embodiment is provided to present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers.

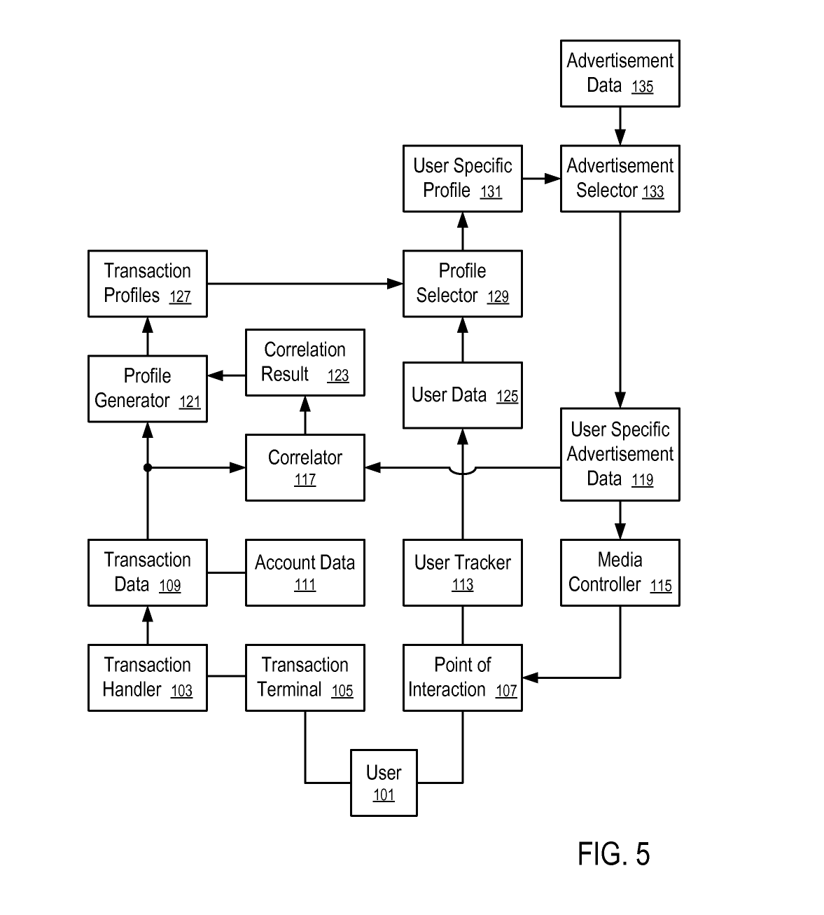

FIG. 5 illustrates a system to provide services based on transaction data according to one embodiment. In FIG. 5, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In FIG. 5, the system further includes a correlator (117) to correlate user specific advertisement data (119) with transactions resulting from the user specific advertisement data (119). The correlation results (123) can be used by the profile generator (121) to improve the transaction profiles (127).

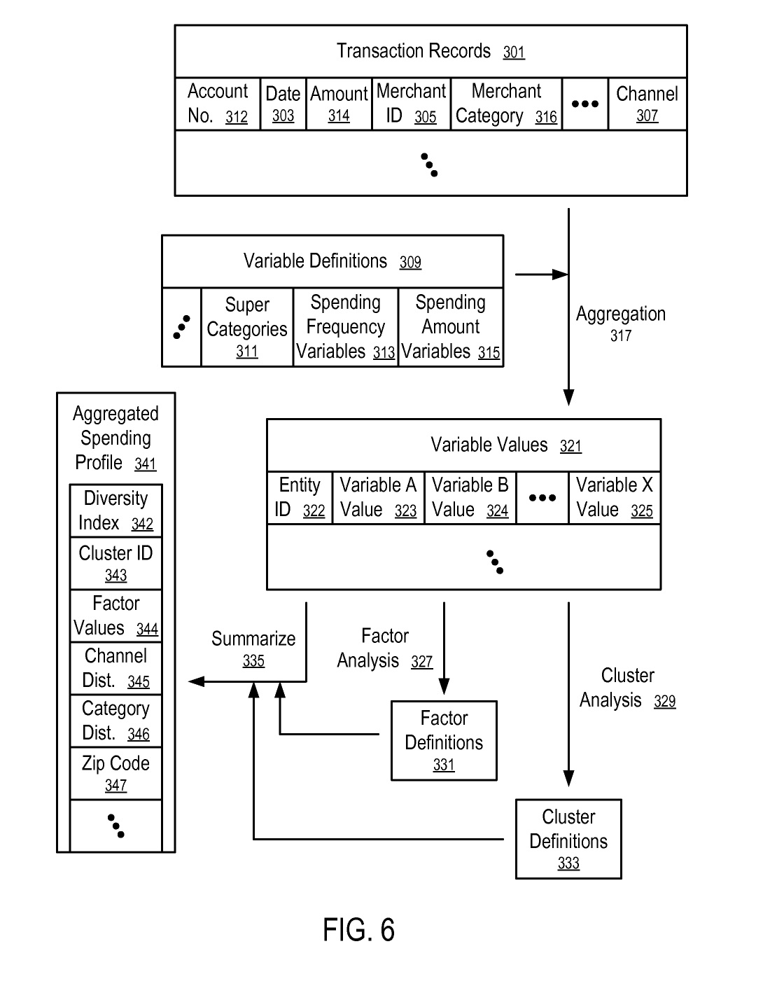

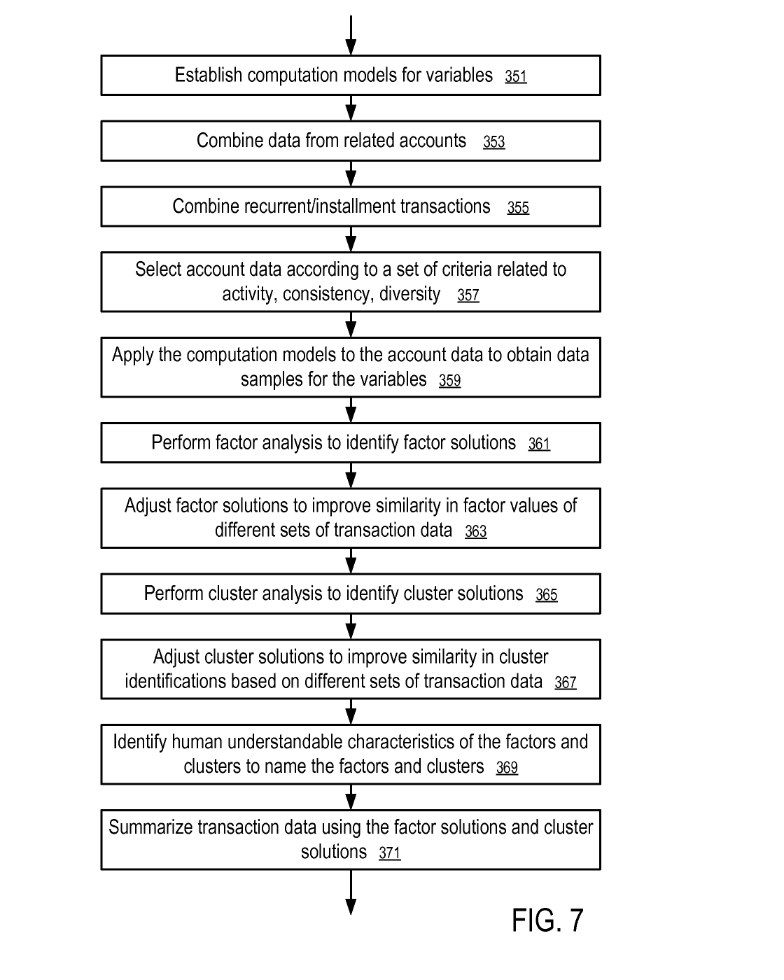

The transaction profiles (127) of one embodiment are generated from the transaction data (109) in a way as illustrated in FIGS. 6 and 7. For example, in FIG. 7, an aggregated spending profile (341) is generated via the factor analysis (327) and cluster analysis (329) to summarize (335) the spending patterns/behaviors reflected in the transaction records (301).

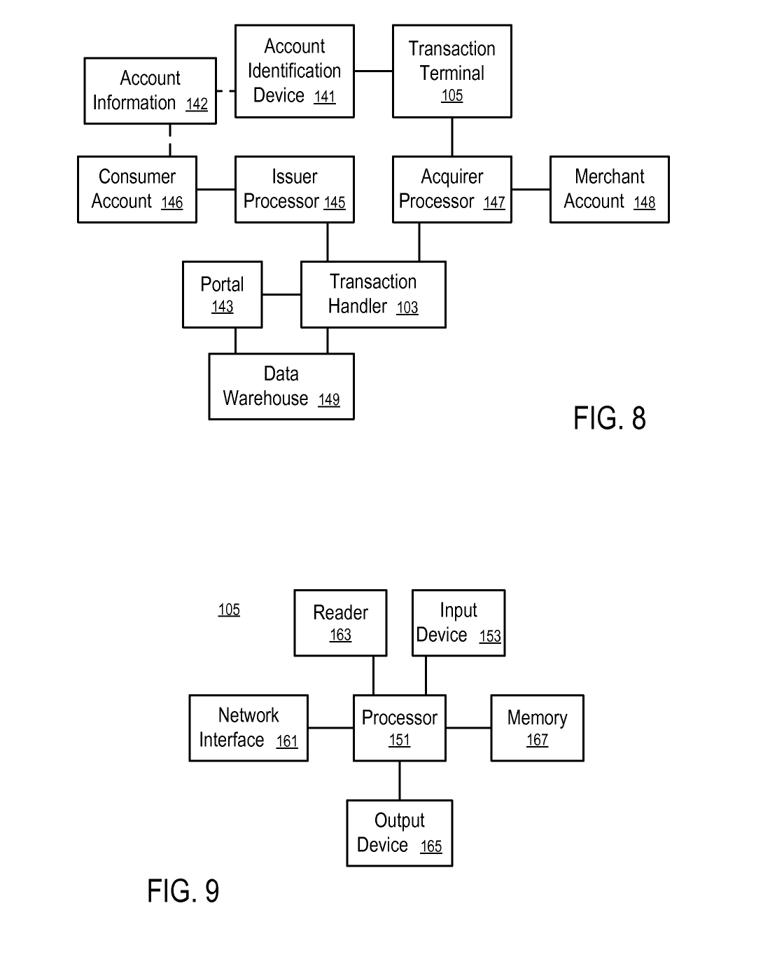

In one embodiment, a data warehouse (149) as illustrated in FIG. 8 is coupled with the transaction handler (103) to store the transaction data (109) and other data, such as account data (111), transaction profiles (127) and correlation results (123). In FIG. 8, a portal (143) is coupled with the data warehouse (149) to provide data or information derived from the transaction data (109), in response to a query request from a third party or as an alert or notification message.

In FIG. 8, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

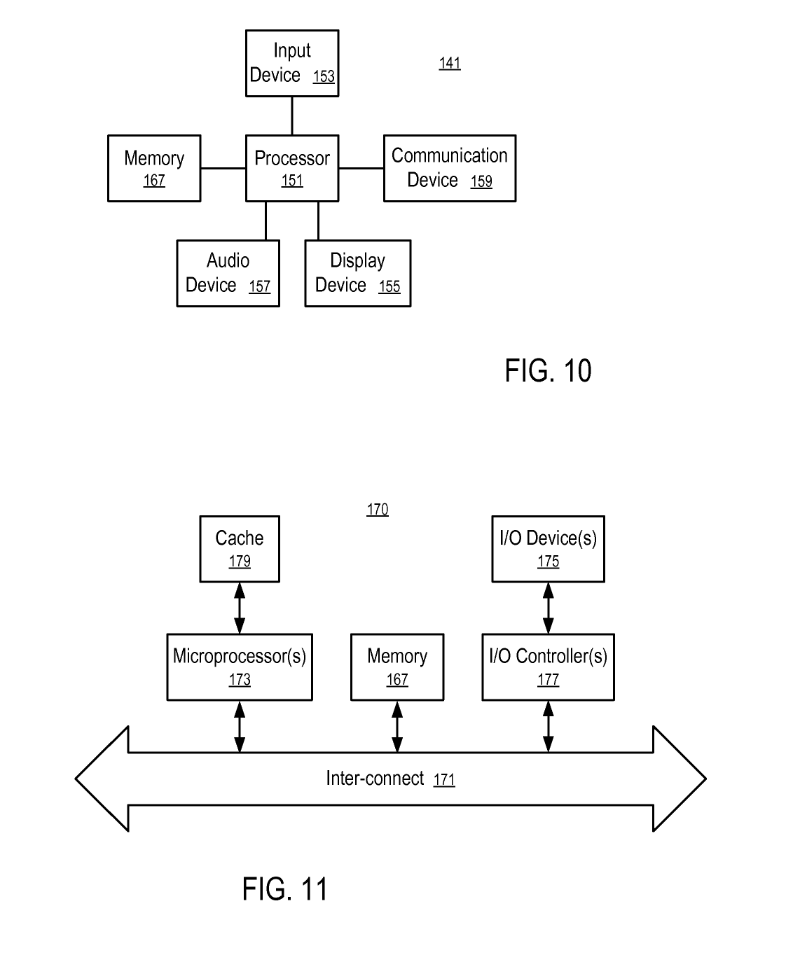

FIGS. 9 and 10 illustrate examples of transaction terminals (105) and account identification devices (141). FIG. 11 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated in FIGS. 5 and 8-11, as further discussed in the section entitled “VARIATIONS.”

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127, 341).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

### Centralized Data Warehouse

In one embodiment, the transaction handler (103) couples with a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section.

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records (301) between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

### Transaction Profile

In FIG. 5, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. patent application Ser. No. 12/614,603, filed Nov. 9, 2009, assigned U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) provides at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

The profile generator (121) may generate and update the transaction profiles (127) in batch mode periodically, or generates the transaction profiles (127) in real time, or just in time, in response to a request received in the portal (143) for such profiles.

The transaction profiles (127) of one embodiment include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Further details and examples about the transaction profiles (127) in one embodiment are provided in the section entitled “AGGREGATED SPENDING PROFILE.”

### Non-Transactional Data

In one embodiment, the transaction data (109) is analyzed in connection with non-transactional data to generate transaction profiles (127) and/or to make predictive models.

In one embodiment, transactions are correlated with non-transactional events, such as news, conferences, shows, announcements, market changes, natural disasters, etc. to establish cause and effect relations to predict future transactions or spending patterns. For example, non-transactional data may include the geographic location of a news event, the date of an event from an events calendar, the name of a performer for an upcoming concert, etc. The non-transactional data can be obtained from various sources, such as newspapers, websites, blogs, social networking sites, etc.

When the cause and effect relationships between the transactions and non-transactional events are known (e.g., based on prior research results, domain knowledge, expertise), the relationships can be used in predictive models to predict future transactions or spending patterns, based on events that occurred recently or are happening in real time.

In one embodiment, the non-transactional data relates to events that happened in a geographical area local to the user (101) that performed the respective transactions. In one embodiment, a geographical area is local to the user (101) when the distance from the user (101) to locations in the geographical area is within a convenient range for daily or regular travel, such as 20, 50 or 100 miles from an address of the user (101), or within the same city or zip code area of an address of the user (101). Examples of analyses of local non-transactional data in connection with transaction data (109) in one embodiment are provided in U.S. patent application Ser. No. 12/614,603, filed Nov. 9, 2009, assigned U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the non-transactional data is not limited to local non-transactional data. For example, national non-transactional data can also be used.

In one embodiment, the transaction records (301) are analyzed in frequency domain to identify periodic features in spending events. The periodic features in the past transaction records (301) can be used to predict the probability of a time window in which a similar transaction would occur. For example, the analysis of the transaction data (109) can be used to predict when a next transaction having the periodic feature would occur, with which merchant, the probability of a repeated transaction with a certain amount, the probability of exception, the opportunity to provide an advertisement or offer such as a coupon, etc. In one embodiment, the periodic features are detected through counting the number of occurrences of pairs of transactions that occurred within a set of predetermined time intervals and separating the transaction pairs based on the time intervals. Some examples and techniques for the prediction of future transactions based on the detection of periodic features in one embodiment are provided in U.S. patent application Ser. No. 12/773,770, filed May 4, 2010, assigned U.S. Pat. App. Pub. No. 2010/0280882, and entitled “Frequency-Based Transaction Prediction and Processing,” the disclosure of which is hereby incorporated herein by reference.

Techniques and details of predictive modeling in one embodiment are provided in U.S. Pat. Nos. 6,119,103, 6,018,723, 6,658,393, 6,598,030, and 7,227,950, the disclosures of which are hereby incorporated herein by reference.

In one embodiment, offers are based on the point-of-service to offeree distance to allow the user (101) to obtain in-person services. In one embodiment, the offers are selected based on transaction history and shopping patterns in the transaction data (109) and/or the distance between the user (101) and the merchant. In one embodiment, offers are provided in response to a request from the user (101), or in response to a detection of the location of the user (101). Examples and details of at least one embodiment are provided in U.S. patent application Ser. No. 11/767,218, filed Jun. 22, 2007, assigned U.S. Pat. App. Pub. No. 2008/0319843, and entitled “Supply of Requested Offer Based on Point-of Service to Offeree Distance,” U.S. patent application Ser. No. 11/755,575, filed May 30, 2007, assigned U.S. Pat. App. Pub. No. 2008/0300973, and entitled “Supply of Requested Offer Based on Offeree Transaction History,” U.S. patent application Ser. No. 11/855,042, filed Sep. 13, 2007, assigned U.S. Pat. App. Pub. No. 2009/0076896, and entitled “Merchant Supplied Offer to a Consumer within a Predetermined Distance,” U.S. patent application Ser. No. 11/855,069, filed Sep. 13, 2007, assigned U.S. Pat. App. Pub. No. 2009/0076925, and entitled “Offeree Requested Offer Based on Point-of Service to Offeree Distance,” and U.S. patent application Ser. No. 12/428,302, filed Apr. 22, 2009, assigned U.S. Pat. App. Pub. No. 2010/0274627, and entitled “Receiving an Announcement Triggered by Location Data,” the disclosures of which applications are hereby incorporated herein by reference.

### Targeting Advertisement

In FIG. 5, an advertisement selector (133) prioritizes, generates, selects, adjusts, and/or customizes the available advertisement data (135) to provide user specific advertisement data (119) based at least in part on the user specific profile (131). The advertisement selector (133) uses the user specific profile (131) as a filter and/or a set of criteria to generate, identify, select and/or prioritize advertisement data for the user (101). A media controller (115) delivers the user specific advertisement data (119) to the point of interaction (107) for presentation to the user (101) as the targeted and/or personalized advertisement.

In one embodiment, the user data (125) includes the characterization of the context at the point of interaction (107). Thus, the use of the user specific profile (131), selected using the user data (125), includes the consideration of the context at the point of interaction (107) in selecting the user specific advertisement data (119).

In one embodiment, in selecting the user specific advertisement data (119), the advertisement selector (133) uses not only the user specific profile (131), but also information regarding the context at the point of interaction (107). For example, in one embodiment, the user data (125) includes information regarding the context at the point of interaction (107); and the advertisement selector (133) explicitly uses the context information in the generation or selection of the user specific advertisement data (119).

In one embodiment, the advertisement selector (133) may query for specific information regarding the user (101) before providing the user specific advertisement data (119). The queries may be communicated to the operator of the transaction handler (103) and, in particular, to the transaction handler (103) or the profile generator (121). For example, the queries from the advertisement selector (133) may be transmitted and received in accordance with an application programming interface or other query interface of the transaction handler (103), the profile generator (121) or the portal (143) of the transaction handler (103).

In one embodiment, the queries communicated from the advertisement selector (133) may request intelligence information regarding the user (101) at any level of specificity (e.g., segment level, individual level). For example, the queries may include a request for a certain field or type of information in a cardholder's aggregate spending profile (341). As another example, the queries may include a request for the spending level of the user (101) in a certain merchant category over a prior time period (e.g., six months).

In one embodiment, the advertisement selector (133) is operated by an entity that is separate from the entity that operates the transaction handler (103). For example, the advertisement selector (133) may be operated by a search engine, a publisher, an advertiser, an ad network, or an online merchant. The user specific profile (131) is provided to the advertisement selector (133) to assist the customization of the user specific advertisement data (119).

In one embodiment, advertising is targeted based on shopping patterns in a merchant category (e.g., as represented by a Merchant Category Code (MCC)) that has high correlation of spending propensity with other merchant categories (e.g., other MCCs). For example, in the context of a first MCC for a targeted audience, a profile identifying second MCCs that have high correlation of spending propensity with the first MCC can be used to select advertisements for the targeted audience.

In one embodiment, the aggregated spending profile (341) is used to provide intelligence information about the spending patterns, preferences, and/or trends of the user (101). For example, a predictive model can be established based on the aggregated spending profile (341) to estimate the needs of the user (101). For example, the factor values (344) and/or the cluster ID (343) in the aggregated spending profile (341) can be used to determine the spending preferences of the user (101). For example, the channel distribution (345) in the aggregated spending profile (341) can be used to provide a customized offer targeted for a particular channel, based on the spending patterns of the user (101).

In one embodiment, mobile advertisements, such as offers and coupons, are generated and disseminated based on aspects of prior purchases, such as timing, location, and nature of the purchases, etc. In one embodiment, the size of the benefit of the offer or coupon is based on purchase volume or spending amount of the prior purchase and/or the subsequent purchase that may qualify for the redemption of the offer. Further details and examples of one embodiment are provided in U.S. patent application Ser. No. 11/960,162, filed Dec. 19, 2007, assigned U.S. Pat. App. Pub. No. 2008/0201226, and entitled “Mobile Coupon Method and Portable Consumer Device for Utilizing Same,” the disclosure of which is hereby incorporated herein by reference.

In one embodiment, conditional rewards are provided to the user (101); and the transaction handler (103) monitors the transactions of the user (101) to identify redeemable rewards that have satisfied the respective conditions. In one embodiment, the conditional rewards are selected based on transaction data (109). Further details and examples of one embodiment are provided in U.S. patent application Ser. No. 11/862,487, filed Sep. 27, 2007, assigned U.S. Pat. App. Pub. No. 2008/0082418, and entitled “Consumer Specific Conditional Rewards,” the disclosure of which is hereby incorporated herein by reference. The techniques to detect the satisfied conditions of conditional rewards can also be used to detect the transactions that satisfy the conditions specified to locate the transactions that result from online activities, such as online advertisements, searches, etc., to correlate the transactions with the respective online activities.

Further details about targeted offer delivery in one embodiment are provided in U.S. patent application Ser. No. 12/185,332, filed Aug. 4, 2008, assigned U.S. Pat. App. Pub. No. 2010/0030644, and entitled “Targeted Advertising by Payment Processor History of Cashless Acquired Merchant Transaction on Issued Consumer Account,” and in U.S. patent application Ser. No. 12/849,793, filed Aug. 3, 2010, assigned U.S. Pat. App. Pub. No. 2011/0035280, and entitled “Systems and Methods for Targeted Advertisement Delivery,” the disclosures of which applications are hereby incorporated herein by reference.

### Profile Matching

In FIG. 5, the user tracker (113) obtains and generates context information about the user (101) at the point of interaction (107), including user data (125) that characterizes and/or identifies the user (101). The profile selector (129) selects a user specific profile (131) from the set of transaction profiles (127) generated by the profile generator (121), based on matching the characteristics of the transaction profiles (127) and the characteristics of the user data (125). For example, the user data (125) indicates a set of characteristics of the user (101); and the profile selector (129) selects the user specific profile (131) that is for a particular user or a group of users and that best matches the set of characteristics specified by the user data (125).

In one embodiment, the profile selector (129) receives the transaction profiles (127) in a batch mode. The profile selector (129) selects the user specific profile (131) from the batch of transaction profiles (127) based on the user data (125). Alternatively, the profile generator (121) generates the transaction profiles (127) in real time; and the profile selector (129) uses the user data (125) to query the profile generator (121) to generate the user specific profile (131) in real time, or just in time. The profile generator (121) generates the user specific profile (131) that best matches the user data (125).

In one embodiment, the user tracker (113) identifies the user (101) based on the user activity on the transaction terminal (105) (e.g., having visited a set of websites, currently visiting a type of web pages, search behavior, etc.).

In one embodiment, the user data (125) includes an identifier of the user (101), such as a global unique identifier (GUID), a personal account number (PAN) (e.g., credit card number, debit card number, or other card account number), or other identifiers that uniquely and persistently identify the user (101) within a set of identifiers of the same type. Alternatively, the user data (125) may include other identifiers, such as an Internet Protocol (IP) address of the user (101), a name or user name of the user (101), or a browser cookie ID, which identify the user (101) in a local, temporary, transient and/or anonymous manner. Some of these identifiers of the user (101) may be provided by publishers, advertisers, ad networks, search engines, merchants, or the user tracker (113). In one embodiment, such identifiers are correlated to the user (101) based on the overlapping or proximity of the time period of their usage to establish an identification reference table.

In one embodiment, the identification reference table is used to identify the account information (142) (e.g., account number (312)) based on characteristics of the user (101) captured in the user data (125), such as browser cookie ID, IP addresses, and/or timestamps on the usage of the IP addresses. In one embodiment, the identification reference table is maintained by the operator of the transaction handler (103). Alternatively, the identification reference table is maintained by an entity other than the operator of the transaction handler (103).

In one embodiment, the user tracker (113) determines certain characteristics of the user (101) to describe a type or group of users of which the user (101) is a member. The transaction profile of the group is used as the user specific profile (131). Examples of such characteristics include geographical location or neighborhood, types of online activities, specific online activities, or merchant propensity. In one embodiment, the groups are defined based on aggregate information (e.g., by time of day, or household), or segment (e.g., by cluster, propensity, demographics, cluster IDs, and/or factor values). In one embodiment, the groups are defined in part via one or more social networks. For example, a group may be defined based on social distances to one or more users on a social network website, interactions between users on a social network website, and/or common data in social network profiles of the users in the social network website.

In one embodiment, the user data (125) may match different profiles at a different granularity or resolution (e.g., account, user, family, company, neighborhood, etc.), with different degrees of certainty. The profile selector (129) and/or the profile generator (121) may determine or select the user specific profile (131) with the finest granularity or resolution with acceptable certainty. Thus, the user specific profile (131) is most specific or closely related to the user (101).

In one embodiment, the advertisement selector (133) uses further data in prioritizing, selecting, generating, customizing and adjusting the user specific advertisement data (119). For example, the advertisement selector (133) may use search data in combination with the user specific profile (131) to provide benefits or offers to a user (101) at the point of interaction (107). For example, the user specific profile (131) can be used to personalize the advertisement, such as adjusting the placement of the advertisement relative to other advertisements, adjusting the appearance of the advertisement, etc.

### Browser Cookie

In one embodiment, the user data (125) uses browser cookie information to identify the user (101). The browser cookie information is matched to account information (142) or the account number (312) to identify the user specific profile (131), such as aggregated spending profile (341) to present effective, timely, and relevant marketing information to the user (101), via the preferred communication channel (e.g., mobile communications, web, mail, email, POS, etc.) within a window of time that could influence the spending behavior of the user (101). Based on the transaction data (109), the user specific profile (131) can improve audience targeting for online advertising. Thus, customers will get better advertisements and offers presented to them; and the advertisers will achieve better return-on-investment for their advertisement campaigns.

In one embodiment, the browser cookie that identifies the user (101) in online activities, such as web browsing, online searching, and using social networking applications, can be matched to an identifier of the user (101) in account data (111), such as the account number (312) of a financial payment card of the user (101) or the account information (142) of the account identification device (141) of the user (101). In one embodiment, the identifier of the user (101) can be uniquely identified via matching IP address, timestamp, cookie ID and/or other user data (125) observed by the user tracker (113).

In one embodiment, a look up table is used to map browser cookie information (e.g., IP address, timestamp, cookie ID) to the account data (111) that identifies the user (101) in the transaction handler (103). The look up table may be established via correlating overlapping or common portions of the user data (125) observed by different entities or different user trackers (113).

In one embodiment, the portal (143) is configured to identify the consumer account (146) based on the IP address identified in the user data (125) through mapping the IP address to a street address.

In one embodiment, the portal (143) uses a plurality of methods to identify consumer accounts (146) based on the user data (125). The portal (143) combines the results from the different methods to determine the most likely consumer account (146) for the user data (125).

Details about the identification of consumer account (146) based on user data (125) in one embodiment are provided in U.S. patent application Ser. No. 12/849,798, filed Aug. 3, 2010, assigned U.S. Pat. App. Pub. No. 2011/0093327, and entitled “Systems and Methods to Match Identifiers,” the disclosure of which is hereby incorporated herein by reference.

### Close the Loop

In one embodiment, the correlator (117) is used to “close the loop” for the tracking of consumer behavior across an on-line activity and an “off-line” activity that results at least in part from the on-line activity. In one embodiment, online activities, such as searching, web browsing, social networking, and/or consuming online advertisements, are correlated with respective transactions to generate the correlation result (123) in FIG. 5. The respective transactions may occur offline, in “brick and mortar” retail stores, or online but in a context outside the online activities, such as a credit card purchase that is performed in a way not visible to a search company that facilitates the search activities.

The correlator (117) is configured in one embodiment to identify transactions resulting from searches or online advertisements. For example, in response to a query about the user (101) from the user tracker (113), the correlator (117) identifies an offline transaction performed by the user (101) and sends the correlation result (123) about the offline transaction to the user tracker (113), which allows the user tracker (113) to combine the information about the offline transaction and the online activities to provide significant marketing advantages.

For example, a marketing department could correlate an advertising budget to actual sales. For example, a marketer can use the correlation result (123) to study the effect of certain prioritization strategies, customization schemes, etc. on the impact on the actual sales. For example, the correlation result (123) can be used to adjust or prioritize advertisement placement on a web site, a search engine, a social networking site, an online marketplace, or the like.

In one embodiment, the profile generator (121) uses the correlation result (123) to augment the transaction profiles (127) with data indicating the rate of conversion from searches or advertisements to purchase transactions. In one embodiment, the correlation result (123) is used to generate predictive models to determine what a user (101) is likely to purchase when the user (101) is searching using certain keywords or when the user (101) is presented with an advertisement or offer. In one embodiment, the portal (143) is configured to report the correlation result (123) to a partner, such as a search engine, a publisher, or a merchant, to allow the partner to use the correlation result (123) to measure the effectiveness of advertisements and/or search result customization, to arrange rewards, etc.

In one embodiment, the correlator (117) matches the online activities and the transactions based on matching the user data (125) provided by the user tracker (113) and the records of the transactions, such as transaction data (109) or transaction records (301). In another embodiment, the correlator (117) matches the online activities and the transactions based on the redemption of offers/benefits provided in the user specific advertisement data (119).

In one embodiment, the portal (143) is configured to receive a set of conditions and an identification of the user (101), determine whether there is any transaction of the user (101) that satisfies the set of conditions, and if so, provide indications of the transactions that satisfy the conditions and/or certain details about the transactions, which allows the requester to correlate the transactions with certain user activities, such as searching, web browsing, consuming advertisements, etc.

In one embodiment, the requester may not know the account number (312) of the user (101); and the portal (143) is to map the identifier provided in the request to the account number (312) of the user (101) to provide the requested information. Examples of the identifier being provided in the request to identify the user (101) include an identification of an iFrame of a web page visited by the user (101), a browser cookie ID, an IP address and the day and time corresponding to the use of the IP address, etc.

The information provided by the portal (143) can be used in pre-purchase marketing activities, such as customizing content or offers, prioritizing content or offers, selecting content or offers, etc., based on the spending pattern of the user (101). The content that is customized, prioritized, selected, or recommended may be the search results, blog entries, items for sale, etc.

The information provided by the portal (143) can be used in post-purchase activities. For example, the information can be used to correlate an offline purchase with online activities. For example, the information can be used to determine purchases made in response to media events, such as television programs, advertisements, news announcements, etc.

Details about profile delivery, online activity to offline purchase tracking, techniques to identify the user specific profile (131) based on user data (125) (such as IP addresses), and targeted delivery of advertisement/offer/benefit in some embodiments are provided in U.S. patent application Ser. No. 12/849,789, filed Aug. 3, 2010, assigned U.S. Pat. App. Pub. No. 2011/0035278, and entitled “Systems and Methods for Closing the Loop between Online Activities and Offline Purchases,” the disclosure of which application is incorporated herein by reference.

### Loyalty Program

In one embodiment, the transaction handler (103) uses the account data (111) to store information for third party loyalty programs.

FIG. 12 shows the structure of account data (111) for providing loyalty programs according to one embodiment. In FIG. 12, data related to a third party loyalty program may include an identifier of the loyalty benefit offeror (183) that is linked to a set of loyalty program rules (185) and loyalty record (187) for the loyalty program activities of the account identifier (181). In one embodiment, at least part of the data related to the third party loyalty program is stored under the account identifier (181) of the user (101), such as the loyalty record (187).

FIG. 12 illustrates the data related to one third party loyalty program of a loyalty benefit offeror (183). In one embodiment, the account identifier (181) may be linked to multiple loyalty benefit offerors (e.g., 183), corresponding to different third party loyalty programs. The third party loyalty program of the loyalty benefit offeror (183) provides the user (101), identified by the account identifier (181), with benefits, such as discounts, rewards, incentives, cash back, gifts, coupons, and/or privileges.

In one embodiment, the association between the account identifier (181) and the loyalty benefit offeror (183) in the account data (111) indicates that the user (101) having the account identifier (181) is a member of the loyalty program. Thus, the user (101) may use the account identifier (181) to access privileges afforded to the members of the loyalty programs, such as rights to access a member only area, facility, store, product or service, discounts extended only to members, or opportunities to participate in certain events, buy certain items, or receive certain services reserved for members.

In one embodiment, it is not necessary to make a purchase to use the privileges. The user (101) may enjoy the privileges based on the status of being a member of the loyalty program. The user (101) may use the account identifier (181) to show the status of being a member of the loyalty program.

For example, the user (101) may provide the account identifier (181) (e.g., the account number of a credit card) to the transaction terminal (105) to initiate an authorization process for a special transaction which is designed to check the member status of the user (101), as if the account identifier (181) were used to initiate an authorization process for a payment transaction. The special transaction is designed to verify the member status of the user (101) via checking whether the account data (111) is associated with the loyalty benefit offeror (183). If the account identifier (181) is associated with the corresponding loyalty benefit offeror (183), the transaction handler (103) provides an approval indication in the authorization process to indicate that the user (101) is a member of the loyalty program. The approval indication can be used as a form of identification to allow the user (101) to access member privileges, such as access to services, products, opportunities, facilities, discounts, permissions, which are reserved for members.

In one embodiment, when the account identifier (181) is used to identify the user (101) as a member to access member privileges, the transaction handler (103) stores information about the access of the corresponding member privilege in loyalty record (187). The profile generator (121) may use the information accumulated in the loyalty record (187) to enhance transaction profiles (127) and provide the user (101) with personalized/targeted advertisements, with or without further offers of benefit (e.g., discounts, incentives, rebates, cash back, rewards, etc.).

In one embodiment, the association of the account identifier (181) and the loyalty benefit offeror (183) also allows the loyalty benefit offeror (183) to access at least a portion of the account data (111) relevant to the loyalty program, such as the loyalty record (187) and certain information about the user (101), such as name, address, and other demographic data.

In one embodiment, the loyalty program allows the user (101) to accumulate benefits according to loyalty program rules (185), such as reward points, cash back, levels of discounts, etc. For example, the user (101) may accumulate reward points for transactions that satisfy the loyalty program rules (185); and the user (101) may use the reward points to redeem cash, gift, discounts, etc. In one embodiment, the loyalty record (187) stores the accumulated benefits; and the transaction handler (103) updates the loyalty record (187) associated with the loyalty benefit offeror (183) and the account identifier (181), when events that satisfy the loyalty program rules occur.

In one embodiment, the accumulated benefits as indicated in the loyalty record (187) can be redeemed when the account identifier (181) is used to perform a payment transaction, when the payment transaction satisfies the loyalty program rules. For example, the user (101) may redeem a number of points to offset or reduce an amount of the purchase price.

In one embodiment, when the user (101) uses the account identifier (181) to make purchases as a member, the merchant may further provide information about the purchases; and the transaction handler (103) can store the information about the purchases as part of the loyalty record (187). The information about the purchases may identify specific items or services purchased by the member. For example, the merchant may provide the transaction handler (103) with purchase details at stock-keeping unit (SKU) level, which are then stored as part of the loyalty record (187). The loyalty benefit offeror (183) may use the purchase details to study the purchase behavior of the user (101); and the profile generator (121) may use the SKU level purchase details to enhance the transaction profiles (127).

In one embodiment, the SKU level purchase details are requested from the merchants or retailers via authorization responses, when the account (146) of the user (101) is enrolled in a loyalty program that allows the transaction handler (103) (and/or the issuer processor (145)) to collect the purchase details.

A method to provide loyalty programs of one embodiment includes the use of the transaction handler (103) as part of a computing apparatus. The computing apparatus processes a plurality of payment card transactions. After the computing apparatus receives a request to track transactions for a loyalty program, such as the loyalty program rules (185), the computing apparatus stores and updates loyalty program information in response to transactions occurring in the loyalty program. The computing apparatus provides to a customer (e.g., 101) an offer of a benefit when the customer satisfies a condition defined in the loyalty program, such as the loyalty program rules (185).

Examples of loyalty programs through collaboration between collaborative constituents in a payment processing system, including the transaction handler (103) in one embodiment are provided in U.S. patent application Ser. No. 11/767,202, filed Jun. 22, 2007, assigned U.S. Pat. App. Pub. No. 2008/0059302, and entitled “Loyalty Program Service,” U.S. patent application Ser. No. 11/848,112, filed Aug. 30, 2007, assigned U.S. Pat. App. Pub. No. 2008/0059306, and entitled “Loyalty Program Incentive Determination,” and U.S. patent application Ser. No. 11/848,179, filed Aug. 30, 2007, assigned U.S. Pat. App. Pub. No. 2008/0059307, and entitled “Loyalty Program Parameter Collaboration,” the disclosures of which applications are hereby incorporated herein by reference.

Examples of processing the redemption of accumulated loyalty benefits via the transaction handler (103) in one embodiment are provided in U.S. patent application Ser. No. 11/835,100, filed Aug. 7, 2007, assigned U.S. Pat. App. Pub. No. 2008/0059303, and entitled “Transaction Evaluation for Providing Rewards,” the disclosure of which is hereby incorporated herein by reference.

In one embodiment, the incentive, reward, or benefit provided in the loyalty program is based on the presence of correlated related transactions. For example, in one embodiment, an incentive is provided if a financial payment card is used in a reservation system to make a reservation and the financial payment card is subsequently used to pay for the reserved good or service. Further details and examples of one embodiment are provided in U.S. patent application Ser. No. 11/945,907, filed Nov. 27, 2007, assigned U.S. Pat. App. Pub. No. 2008/0071587, and entitled “Incentive Wireless Communication Reservation,” the disclosure of which is hereby incorporated herein by reference.

In one embodiment, the transaction handler (103) provides centralized loyalty program management, reporting and membership services. In one embodiment, membership data is downloaded from the transaction handler (103) to acceptance point devices, such as the transaction terminal (105). In one embodiment, loyalty transactions are reported from the acceptance point devices to the transaction handler (103); and the data indicating the loyalty points, rewards, benefits, etc. are stored on the account identification device (141). Further details and examples of one embodiment are provided in U.S. patent application Ser. No. 10/401,504, filed Mar. 27, 2003, assigned U.S. Pat. App. Pub. No. 2004/0054581, and entitled “Network Centric Loyalty System,” the disclosure of which is hereby incorporated herein by reference.

In one embodiment, the portal (143) of the transaction handler (103) is used to manage reward or loyalty programs for entities such as issuers, merchants, etc. The cardholders, such as the user (101), are rewarded with offers/benefits from merchants. The portal (143) and/or the transaction handler (103) track the transaction records for the merchants for the reward or loyalty programs. Further details and examples of one embodiment are provided in U.S. patent application Ser. No. 11/688,423, filed Mar. 20, 2007, assigned U.S. Pat. App. Pub. No. 2008/0195473, and entitled “Reward Program Manager,” the disclosure of which is hereby incorporated herein by reference.

In one embodiment, a loyalty program includes multiple entities providing access to detailed transaction data, which allows the flexibility for the customization of the loyalty program. For example, issuers or merchants may sponsor the loyalty program to provide rewards; and the portal (143) and/or the transaction handler (103) stores the loyalty currency in the data warehouse (149). Further details and examples of one embodiment are provided in U.S. patent application Ser. No. 12/177,530, filed Jul. 22, 2008, assigned U.S. Pat. App. Pub. No. 2009/0030793, and entitled “Multi-Vender Multi-Loyalty Currency Program,” the disclosure of which is hereby incorporated herein by reference.

In one embodiment, an incentive program is created on the portal (143) of the transaction handler (103). The portal (143) collects offers from a plurality of merchants and stores the offers in the data warehouse (149). The offers may have associated criteria for their distributions. The portal (143) and/or the transaction handler (103) may recommend offers based on the transaction data (109). In one embodiment, the transaction handler (103) automatically applies the benefits of the offers during the processing of the transactions when the transactions satisfy the conditions associated with the offers. In one embodiment, the transaction handler (103) communicates with transaction terminals (105) to set up, customize, and/or update offers based on market focus, product categories, service categories, targeted consumer demographics, etc.

Further details and examples of one embodiment are provided in U.S. patent application Ser. No. 12/413,097, filed Mar. 27, 2009, assigned U.S. Pat. App. Pub. No. 2010/0049620, and entitled “Merchant Device Support of an Integrated Offer Network,” the disclosure of which is hereby incorporated herein by reference.

In one embodiment, the transaction handler (103) is configured to provide offers from merchants to the user (101) via the payment system, making accessing and redeeming the offers convenient for the user (101). The offers may be triggered by and/or tailored to a previous transaction, and may be valid only for a limited period of time starting from the date of the previous transaction. If the transaction handler (103) determines that a subsequent transaction processed by the transaction handler (103) meets the conditions for the redemption of an offer, the transaction handler (103) may credit the consumer account (146) for the redemption of the offer and/or provide a notification message to the user (101). Further details and examples of one embodiment are provided in U.S. patent application Ser. No. 12/566,350, filed Sep. 24, 2009, assigned U.S. Pat. App. Pub. No. 2010/0114686, and entitled “Real-Time Statement Credits and Notifications,” the disclosure of which is hereby incorporated herein by reference.

Details on loyalty programs in one embodiment are provided in U.S. patent application Ser. No. 12/896,632, filed Oct. 1, 2010, assigned U.S. Pat. App. Pub. No. 2011/0087530, and entitled “Systems and Methods to Provide Loyalty Programs,” the disclosure of which is hereby incorporated herein by reference.

### SKU

In one embodiment, merchants generate stock-keeping unit (SKU) or other specific information that identifies the particular goods and services purchased by the user (101) or customer. The SKU information may be provided to the operator of the transaction handler (103) that processed the purchases. The operator of the transaction handler (103) may store the SKU information as part of transaction data (109), and reflect the SKU information for a particular transaction in a transaction profile (127 or 131) associated with the person involved in the transaction.

When a user (101) shops at a traditional retail store or browses a website of an online merchant, an SKU-level profile associated specifically with the user (101) may be provided to select an advertisement appropriately targeted to the user (101) (e.g., via mobile phones, POS terminals, web browsers, etc.). The SKU-level profile for the user (101) may include an identification of the goods and services historically purchased by the user (101). In addition, the SKU-level profile for the user (101) may identify goods and services that the user (101) may purchase in the future. The identification may be based on historical purchases reflected in SKU-level profiles of other individuals or groups that are determined to be similar to the user (101). Accordingly, the return on investment for advertisers and merchants can be greatly improved.

In one embodiment, the user specific profile (131) is an aggregated spending profile (341) that is generated using the SKU-level information. For example, in one embodiment, the factor values (344) correspond to factor definitions (331) that are generated based on aggregating spending in different categories of products and/or services. A typical merchant offers products and/or services in many different categories.

In one embodiment, based on the SKU information and perhaps other transaction data, the profile generator (121) may create an SKU-level transaction profile for the user (101). In one embodiment, based on the SKU information associated with the transactions for each person entering into transactions with the operator of the transaction handler (103), the profile generator (121) may create an SKU-level transaction profile for each person.

Details on SKU-level profile in one embodiment are provided in U.S. patent application Ser. No. 12/899,144, filed Oct. 6, 2010, assigned U.S. Pat. App. Pub. No. 2011/0093335, and entitled “Systems and Methods for Advertising Services Based on an SKU-Level Profile,” the disclosure of which is hereby incorporated herein by reference.

### Real-Time Messages

In one embodiment, the transaction handler (103) is configured to cooperate with the media controller (115) to facilitate real-time interaction with the user (101) when the payment of the user (101) is being processed by the transaction handler (103). The real-time interaction provides the opportunity to impact the user experience during the purchase (e.g., at the time of card swipe), through delivering messages in real-time to a point of interaction (107), such as a mobile phone, a personal digital assistant, a portable computer, etc. The real-time message can be delivered via short message service (SMS), email, instant messaging, or other communications protocols.

In one embodiment, the real-time message is provided without requiring modifications to existing systems used by the merchants and/or issuers.

FIG. 13 shows a system to provide real-time messages according to one embodiment. In FIG. 13, the transaction handler (103) (or a separate computing system coupled with the transaction handler (103)) is to detect the occurrence of certain transactions of interest during the processing of the authorization requests received from the transaction terminal (105); a message broker (201) is to identify a relevant message for the user (101) associated with the corresponding authorization request; and the media controller (115) is to provide the message to the user (101) at the point of interaction (107) via a communication channel separate from the channel used by the transaction handler (103) to respond to the corresponding authorization request submitted from the transaction terminal (105).

In one embodiment, the media controller (115) is to provide the message to the point of interaction (107) in parallel with the transaction handler (103) providing the response to the authorization request.

In one embodiment, the point of interaction (107) receives the message from the media controller (115) in real-time with the transaction handler (103) processing the authorization request. In one embodiment, the message is to arrive at the point of interaction (107) in the context of the response provided from the transaction handler (103) to the transaction terminal (105). For example, the message is to arrive at the point of interaction (107) substantially at the same time as the response to the authorization request arrives at the transaction terminal, or with a delay not long enough to cause the user (101) to have the impression that the message is in response to an action other that the payment transaction. For example, the message is to arrive at the point of interaction (107) prior to the user (101) completing the transaction and leaving the transaction terminal (105), or prior to the user (101) leaving the retail location of the merchant operating the transaction terminal (105).

In FIG. 13, the system includes a portal (143) to provide services to merchants and/or the user (101).

For example, in one embodiment, the portal (143) allows the user (101) to register the communication reference (205) in association with the account data (111), such as the account information (142) of the consumer account (146); and the media controller (115) is to use the communication reference (205) to deliver the message to the point of interaction (107). Examples of the communication reference (205) includes a mobile phone number, an email address, a user identifier of an instant messaging system, an IP address, etc.

In one embodiment, the portal (143) allows merchants and/or other parties to define rules (203) to provide offers (186) as real-time responses to authorization requests; and based on the offer rules (203), the message broker (201) is to generate, or instruct the media controller to generate, the real-time message to provide the offers (186) to the user (101). For example, the offer (186) may include a discount, an incentive, a reward, a rebate, a gift, or other benefit, which can be redeemed upon the satisfaction of certain conditions required by the offer rules (203). In one embodiment, based on the offer rules (203) the message broker (201) configures a message by selecting the appropriate message template from (an) existing message(s) template(s), and inserts any relevant data (e.g., the communication reference (205)) into the selected template, then passes the configured message to the media controller (115), which delivers the message to the point of interaction (107). In one embodiment, the message broker (201) (or a subsystem) is used to manage message templates along with the rules for selecting the appropriate message template from among several potential choices.

In one embodiment, the offer rules (203) include offer details, targeting rules, advertisement campaign details, profile mapping, creative mapping, qualification rules, award/notify/fulfillment rules, approvals, etc. Creative elements for offers include text, images, channels, approvals, etc.

In one embodiment, when the offer rules (203) are activated by the merchant or advertiser via the portal (143), the message broker (201) is to generate trigger records (207) for the transaction handler (103). The transaction handler (103) is to monitor the incoming authorization requests to identify requests that satisfy the conditions specified in the trigger records (207) during the process of the authorization requests, and to provide the information about the identified requests to the message broker (201) for the transmission of an appropriate real-time message in accordance with the offer rules (203).

In one embodiment, the generation of the trigger records (207) for the transaction handler (103) is in real-time with the merchant or advertiser activating the offer rules (203). Thus, the offer rules (203) can be activated and used for the detection of the new authorization requests in real-time, while the transaction handler (103) continues to process the incoming authorization requests.

In one embodiment, the portal (143) provides information about the spending behaviors reflected in the transaction data (109) to assist the merchants or advertisers to target offers or advertisements. For example, in one embodiment, the portal (143) allows merchants to target the offers (186) based on transaction profiles (127). For example, the offer rules (203) are partially based on the values in a transaction profile (127), such as an aggregated spending profile (341). In one embodiment, the offer rules (203) are partially based on the information about the last purchase of the user (101) from the merchant operating the transaction terminal (105) (or another merchant), and/or the information about the location of the user (101), such as the location determined based on the location of the transaction terminal (105) and/or the location of the merchant operating the transaction terminal (105).

In one embodiment, the portal (143) provides transaction based statistics, such as merchant benchmarking statistics, industry/market segmentation, etc., to assist merchants and advertisers to identify customers.

Thus, the real-time messages can be used to influence customer behaviors while the customers are in the purchase mode.

In one embodiment, the benefit of the offers (186) can be redeemed via the transaction handler (103). The redemption of the offer (186) may or may not require the purchase details (e.g., SKU level purchase details). Details in one embodiment about redeeming offers (186) via the transaction handler (103) are provided in U.S. patent application Ser. No. 13/113,710, filed May 23, 2011 and entitled “Systems and Methods for Redemption of Offers,” the disclosure of which is hereby incorporated herein by reference.

In one embodiment, when the authorization request for a purchase indicates that the purchase qualifies the offer (186) for redemption if the purchase corresponding to the authorization request is completed, the message broker (201) is to construct a message and use the media controller (115) to deliver the message in real-time with the processing of the authorization request to the point of interaction (107). The message informs the user (101) that when the purchase is completed, the transaction handler (103) and/or the issuer processor (145) is to provide the benefit of the offer (186) to the user (101) via statement credit or some other settlement value, for example points in a registered loyalty program, or credit at the point of sale using a digital coupon delivered to the purchaser via cell phone.

In one embodiment, the settlement of the payment transaction corresponding to the authorization request does not occur in real-time with the processing of the authorization request. For example, the merchant may submit the complete purchases for settlement at the end of the day, or in accordance with a predetermined schedule. The settlement may occur one or more days after the processing of the authorization request.

In one embodiment, when transactions are settled, the settled transactions are matched to the authorization requests to identify offers (186) that are redeemable in view of the settlement. When the offer (186) is confirmed to be redeemable based on a record of successful settlement, the message broker (201) is to use the media controller (115) to provide a message to the point of interaction (107) of the user (101), such as the mobile phone of the user (101). In one embodiment, the message is to inform the user (101) of the benefit to be provided as statement credits and/or to provide additional offers. In one embodiment, the message to confirm the statement credits is transmitted in real-time with the completion of the transaction settlement.

In one embodiment, the message broker (201) is to determine the identity of the merchant based on the information included in the authorization request transmitted from the transaction terminal (105) to the transaction handler (103). In one embodiment, the identity of the merchant is normalized to allow the application of the offer rules (203) that are merchant specific.

In one embodiment, the portal (143) is to provide data insight to merchants and/or advertisers. For example, the portal (143) can provide the transaction profile (127) of the user (101), audience segmentation information, etc.

In one embodiment, the portal (143) is to allow the merchants and/or advertisers to define and manage offers for their creation, fulfillment and/or delivery in messages.

In one embodiment, the portal (143) allows the merchants and/or advertisers to test, run and/or monitor the offers (186) for their creation, fulfillment and/or delivery in messages.

In one embodiment, the portal (143) is to provide reports and analytics regarding the offers (186).

In one embodiment, the portal (143) provides operation facilities, such as onboarding, contact management, certification, file management, workflow, etc. to assist the merchants and/or advertisers to complete the tasks related to the offers (186).

In one embodiment, the portal (143) allows the user (101) to opt in or opt out of the real-time message delivery service.

In one embodiment, an advertiser or merchant can select an offer fulfillment method from a list of options, such as statement credits, points, gift cards, e-certificates, third party fulfillment, etc.

In one embodiment, the merchant or advertiser is to use the “off the rack” transaction profiles (127) available in the data warehouse (149). In one embodiment, the merchant or advertiser can further edit parameters to customize the generation of the transaction profiles (127) and/or develop custom transaction profiles from scratch using the portal (143).

In one embodiment, the portal (143) provides a visualization tool to allow the user to see clusters of data based on GeoCodes, proximity, transaction volumes, spending patterns, zip codes, customers, stores, etc.

In one embodiment, the portal (143) allows the merchant or advertiser to define cells for targeting the customers in the cells based on date/time, profile attributes, map to offer/channel/creative, condition testing, etc.

In one embodiment, the portal (143) allows the merchant or advertiser to monitor the system health, such as the condition of servers, files received or sent, errors, status, etc., the throughput by date or range, by program, by campaign, or by global view, and aspects of current programs/offers/campaigns, such as offer details, package audit reports, etc. In one embodiment, reporting includes analytics and metrics, such as lift, conversion, category differentials (e.g., spending patterns, transaction volumes, peer groups), and reporting by program, campaign, cell, GeoCode, proximity, ad-hoc, auditing, etc.

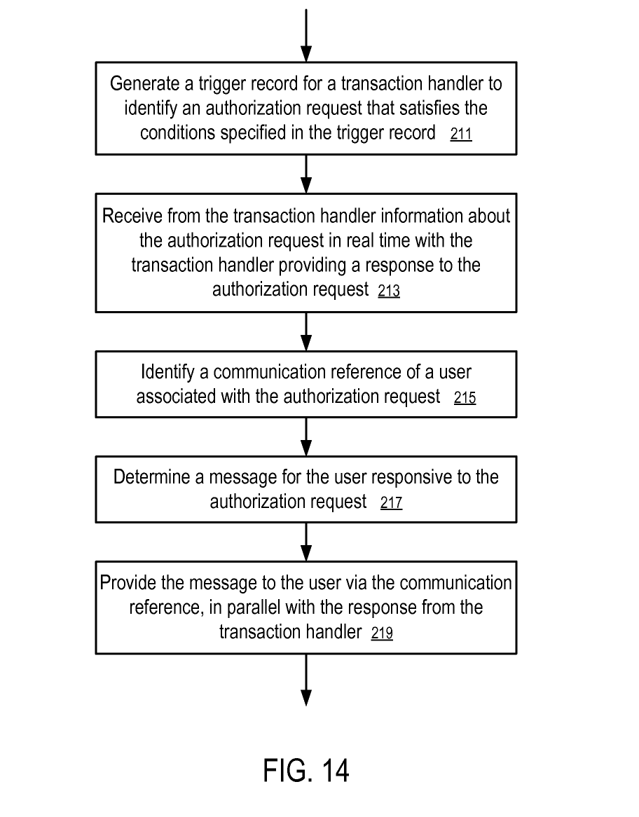

FIG. 14 shows a method to provide real-time messages according to one embodiment. In FIG. 14, a computing apparatus is to generate (211) a trigger record (207) for a transaction handler (103) to identify an authorization request that satisfies the conditions specified in the trigger record (207), receive (213) from the transaction handler (103) information about the authorization request in real-time with the transaction handler (103) providing a response to the authorization request to a transaction terminal (105), identify (215) a communication reference (205) of a user (101) associated with the authorization request, determine (217) a message for the user (101) responsive to the authorization request, and provide (219) the message to the user (101) at a point of interaction (107) via the communication reference (205), in parallel with the response from the transaction handler (103) to the transaction terminal (105).

In one embodiment, the computing apparatus includes at least one of: a transaction handler, a message broker (201), a media controller (115), a portal (143) and a data warehouse.

### Variations

Some embodiments use more or fewer components than those illustrated in the figures.

In one embodiment, at least some of the profile generator (121), correlator (117), profile selector (129), and advertisement selector (133) are controlled by the entity that operates the transaction handler (103). In another embodiment, at least some of the profile generator (121), correlator (117), profile selector (129), and advertisement selector (133) are not controlled by the entity that operates the transaction handler (103).

In one embodiment, the products and/or services purchased by the user (101) are also identified by the information transmitted from the merchants or service providers. Thus, the transaction data (109) may include identification of the individual products and/or services, which allows the profile generator (121) to generate transaction profiles (127) with fine granularity or resolution. In one embodiment, the granularity or resolution may be at a level of distinct products and services that can be purchased (e.g., stock-keeping unit (SKU) level), or category or type of products or services, or vendor of products or services, etc.

In one embodiment, the entity operating the transaction handler (103) provides the intelligence information in real time as the request for the intelligence information occurs. In other embodiments, the entity operating the transaction handler (103) may provide the intelligence information in batch mode. The intelligence information can be delivered via online communications (e.g., via an application programming interface (API) on a website, or other information server), or via physical transportation of a computer readable media that stores the data representing the intelligence information.

In one embodiment, the intelligence information is communicated to various entities in the system in a way similar to, and/or in parallel with the information flow in the transaction system to move money. The transaction handler (103) routes the information in the same way it routes the currency involved in the transactions.

In one embodiment, the portal (143) provides a user interface to allow the user (101) to select items offered on different merchant websites and store the selected items in a wish list for comparison, reviewing, purchasing, tracking, etc. The information collected via the wish list can be used to improve the transaction profiles (127) and derive intelligence on the needs of the user (101); and targeted advertisements can be delivered to the user (101) via the wish list user interface provided by the portal (143). Examples of user interface systems to manage wish lists are provided in U.S. patent application Ser. No. 12/683,802, filed Jan. 7, 2010, assigned U.S. Pat. App. Pub. No. 2010/0174623, and entitled “System and Method for Managing Items of Interest Selected from Online Merchants,” the disclosure of which is hereby incorporated herein by reference.

### Aggregated Spending Profile

In one embodiment, the characteristics of transaction patterns of customers are profiled via clusters, factors, and/or categories of purchases. The transaction data (109) may include transaction records (301); and in one embodiment, an aggregated spending profile (341) is generated from the transaction records (301), in a way illustrated in FIG. 6, to summarize the spending behavior reflected in the transaction records (301).

In FIG. 6, each of the transaction records (301) is for a particular transaction processed by the transaction handler (103). Each of the transaction records (301) provides information about the particular transaction, such as the account number (312) of the consumer account (146) used to pay for the purchase, the date (303) (and/or time) of the transaction, the amount (314) of the transaction, the ID (305) of the merchant who receives the payment, the category (316) of the merchant, the channel (307) through which the purchase was made, etc. Examples of channels include online, offline in-store, via phone, etc. In one embodiment, the transaction records (301) may further include a field to identify a type of transaction, such as card-present, card-not-present, etc.

A “card-present” transaction typically involves physically presenting the account identification device (141), such as a financial transaction card, to the merchant (e.g., via swiping a credit card at a POS terminal of a merchant); and a “card-not-present” transaction typically involves presenting the account information (142) of the consumer account (146) to the merchant to identify the consumer account (146) without physically presenting the account identification device (141) to the merchant or the transaction terminal (105).

The transaction records (301) of one embodiment may further include details about the products and/or services involved in the purchase.

When there is voluminous data representing the transaction records (301), the spending patterns reflected in the transaction records (301) can be difficult to recognize by an ordinary person.

In FIG. 6, the voluminous transaction records (301) are summarized (335) into aggregated spending profiles (e.g., 341) to concisely present the statistical spending characteristics reflected in the transaction records (301). The aggregated spending profile (341) uses values derived from statistical analysis to present the statistical characteristics of transaction records (301) of an entity in a way easy to understand by an ordinary person.

In FIG. 6, the transaction records (301) are summarized (335) via factor analysis (327) to condense the variables (e.g., 313, 315) and via cluster analysis (329) to segregate entities by spending patterns.

In FIG. 6, a set of variables (e.g., 311, 313, 315) are defined based on the parameters recorded in the transaction records (301). The variables (e.g., 311, 313, and 315) are defined in a way to have meanings easily understood by an ordinary person. For example, variables (311) measure the aggregated spending in super categories; variables (313) measure the spending frequencies in various areas; and variables (315) measure the spending amounts in various areas. In one embodiment, each of the areas is identified by a merchant category (316) (e.g., as represented by a merchant category code (MCC), a North American Industry Classification System (NAICS) code, or a similarly standardized category code). In other embodiments, an area may be identified by a product category, a SKU number, etc.

Examples of the spending frequency variables (313) and spending amount variables (315) defined for various merchant categories (e.g., 316) in one embodiment are provided in U.S. patent application Ser. No. 12/537,566, filed Aug. 7, 2009, assigned U.S. Pat. App. Pub. No. 2010/0306029, and entitled “Cardholder Clusters,” and in U.S. patent application Ser. No. 12/777,173, filed May 10, 2010, assigned U.S. Pat. App. Pub. No. 2010/0306032, and entitled “Systems and Methods to Summarize Transaction Data,” the disclosures of which applications are hereby incorporated herein by reference.

In FIG. 6, the aggregation (317) includes the application of the definitions (309) for these variables (e.g., 311, 313, and 315) to the transaction records (301) to generate the variable values (321). The transaction records (301) are aggregated to generate aggregated measurements (e.g., variable values (321)) that are not specific to a particular transaction, such as frequencies of purchases made with different merchants or different groups of merchants, the amounts spent with different merchants or different groups of merchants, and the number of unique purchases across different merchants or different groups of merchants, etc. The aggregation (317) can be performed for a particular time period and for entities at various levels.

The transaction records (301) can be aggregated according to a buying entity, or a selling entity. For example, the aggregation (317) can be performed at account level, person level, family level, company level, neighborhood level, city level, region level, etc. to analyze the spending patterns across various areas (e.g., sellers, products or services) for the respective aggregated buying entity. For example, the transaction records (301) for a particular merchant having transactions with multiple accounts can be aggregated for a merchant level analysis. For example, the transaction records (301) for a particular merchant group can be aggregated for a merchant group level analysis. The aggregation (317) can be formed separately for different types of transactions, such as transactions made online, offline, via phone, and/or “card-present” transactions vs. “card-not-present” transactions, which can be used to identify the spending pattern differences among different types of transactions.

In FIG. 6, the variable values (e.g., 323, 324, . . . , 325) associated with an entity ID (322) are considered the random samples of the respective variables (e.g., 311, 313, 315), sampled for the instance of an entity represented by the entity ID (322). Statistical analyses (e.g., factor analysis (327) and cluster analysis (329)) are performed to identify the patterns and correlations in the random samples.

Once the cluster definitions (333) are obtained from the cluster analysis (329), the identity of the cluster (e.g., cluster ID (343)) that contains the entity ID (322) can be used to characterize spending behavior of the entity represented by the entity ID (322). The entities in the same cluster are considered to have similar spending behaviors.

In FIG. 6, the random variables (e.g., 313 and 315) as defined by the definitions (309) have certain degrees of correlation and are not independent from each other. For example, merchants of different merchant categories (e.g., 316) may have overlapping business, or have certain business relationships. For example, certain products and/or services of certain merchants have cause and effect relationships. For example, certain products and/or services of certain merchants are mutually exclusive to a certain degree (e.g., a purchase from one merchant may have a level of probability to exclude the user (101) from making a purchase from another merchant). Such relationships may be complex and difficult to quantify by merely inspecting the categories. Further, such relationships may shift over time as the economy changes.

In FIG. 6, a factor analysis (327) is performed to reduce the redundancy and/or correlation among the variables (e.g., 313, 315). The factor analysis (327) identifies the definitions (331) for factors, each of which represents a combination of the variables (e.g., 313, 315). A factor from the factor analysis (327) is a linear combination of a plurality of the aggregated measurements (e.g., variables (313, 315)) determined for various areas (e.g., merchants or merchant categories, products or product categories). Once the relationship between the factors and the aggregated measurements is determined via factor analysis, the values for the factors can be determined from the linear combinations of the aggregated measurements and be used in a transaction profile (127 or 341) to provide information on the behavior of the entity represented by the entity ID (e.g., an account, an individual, a family).

Once the factor definitions (331) are obtained from the factor analysis (327), the factor definitions (331) can be applied to the variable values (321) to determine factor values (344) for the aggregated spending profile (341). Since redundancy and correlation are reduced in the factors, the number of factors is typically much smaller than the number of the original variables (e.g., 313, 315). Thus, the factor values (344) represent the concise summary of the original variables (e.g., 313, 315).

For example, there may be thousands of variables on spending frequency and amount for different merchant categories; and the factor analysis (327) can reduce the factor number to less than one hundred (and even less than twenty). In one example, a twelve-factor solution is obtained, which allows the use of twelve factors to combine the thousands of the original variables (313, 315); and thus, the spending behavior in thousands of merchant categories can be summarized via twelve factor values (344). In one embodiment, each factor is combination of at least four variables; and a typical variable has contributions to more than one factor.

In FIG. 6, an aggregated spending profile (341) for an entity represented by an entity ID (e.g., 322) includes the cluster ID (343) and factor values (344) determined based on the cluster definitions (333) and the factor definitions (331). The aggregated spending profile (341) may further include other statistical parameters, such as diversity index (342), channel distribution (345), category distribution (346), zip code (347), etc., as further discussed below.

In general, an aggregated spending profile (341) may include more or fewer fields than those illustrated in FIG. 6. For example, in one embodiment, the aggregated spending profile (341) further includes an aggregated spending amount for a period of time (e.g., the past twelve months); in another embodiment, the aggregated spending profile (341) does not include the category distribution (346); and in a further embodiment, the aggregated spending profile (341) may include a set of distance measures to the centroids of the clusters.

FIG. 7 shows a method to generate an aggregated spending profile according to one embodiment. In FIG. 7, computation models are established (351) for variables (e.g., 311, 313, and 315). In one embodiment, the variables are defined in a way to capture certain aspects of the spending statistics, such as frequency, amount, etc.

In FIG. 7, data from related accounts are combined (353); recurrent/installment transactions are combined (355); and account data are selected (357) according to a set of criteria related to activity, consistency, diversity, etc.

In FIG. 7, the computation models (e.g., as represented by the variable definitions (309)) are applied (359) to the remaining account data (e.g., transaction records (301)) to obtain data samples for the variables. The data points associated with the entities, other than those whose transactions fail to meet the minimum requirements for activity, consistency, diversity, etc., are used in factor analysis (327) and cluster analysis (329).

In FIG. 7, the data samples (e.g., variable values (321)) are used to perform (361) factor analysis (327) to identify factor solutions (e.g., factor definitions (331)). The factor solutions can be adjusted (363) to improve similarity in factor values of different sets of transaction data (109).

The data samples can also be used to perform (365) cluster analysis (329) to identify cluster solutions (e.g., cluster definitions (333)). The cluster solutions can be adjusted (367) to improve similarity in cluster identifications based on different sets of transaction data (109). For example, cluster definitions (333) can be applied to the transactions in the time period under analysis (e.g., the past twelve months) and be applied separately to the transactions in a prior time period (e.g., the twelve months before the past twelve months) to obtain two sets of cluster identifications for various entities. The cluster definitions (333) can be adjusted to improve the correlation between the two set of cluster identifications.

Optionally, human understandable characteristics of the factors and clusters are identified (369) to name the factors and clusters. For example, when the spending behavior of a cluster appears to be the behavior of an internet loyalist, the cluster can be named “internet loyalist” such that if a cardholder is found to be in the “internet loyalist” cluster, the spending preferences and patterns of the cardholder can be easily perceived.

In one embodiment, the factor analysis (327) and the cluster analysis (329) are performed periodically (e.g., once a year, or six months) to update the factor definitions (331) and the cluster definitions (333), which may change as the economy and the society change over time.

In FIG. 7, transaction data (109) are summarized (371) using the factor solutions and cluster solutions to generate the aggregated spending profile (341). The aggregated spending profile (341) can be updated more frequently than the factor solutions and cluster solutions, when the new transaction data (109) becomes available. For example, the aggregated spending profile (341) may be updated quarterly or monthly.

Details about aggregated spending profile (341) in one embodiment are provided in U.S. patent application Ser. No. 12/777,173, filed May 10, 2010, assigned U.S. Pat. App. Pub. No. 2010/0306032, and entitled “Systems and Methods to Summarize Transaction Data,” the disclosure of which is hereby incorporated herein by reference.

### Transaction Processing and Data

In FIG. 8, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

The accumulated transaction data (109) and the corresponding account data (111) are used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

In FIG. 8, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 8, the transaction handler (103) uses the data warehouse (149) to store the records about the transactions, such as the transaction records (301) or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 8, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 8, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

In one embodiment, the portal (143) provides a user interface to allow the user (101) to organize the transactions in one or more consumer accounts (146) of the user with one or more issuers. The user (101) may organize the transactions using information and/or categories identified in the transaction records (301), such as merchant category (316), transaction date (303), amount (314), etc. Examples and techniques in one embodiment are provided in U.S. patent application Ser. No. 11/378,215, filed Mar. 16, 2006, assigned U.S. Pat. App. Pub. No. 2007/0055597, and entitled “Method and System for Manipulating Purchase Information,” the disclosure of which is hereby incorporated herein by reference.

In one embodiment, the portal (143) provides transaction based statistics, such as indicators for retail spending monitoring, indicators for merchant benchmarking, industry/market segmentation, indicators of spending patterns, etc. Further examples can be found in U.S. patent application Ser. No. 12/191,796, filed Aug. 14, 2008, assigned U.S. Pat. App. Pub. No. 2009/0048884, and entitled “Merchant Benchmarking Tool,” U.S. patent application Ser. No. 12/940,562, filed Nov. 5, 2010, and U.S. patent application Ser. No. 12/940,664, filed Nov. 5, 2010, the disclosures of which applications are hereby incorporated herein by reference.

### Transaction Terminal

FIG. 9 illustrates a transaction terminal according to one embodiment. The transaction terminal (105) illustrated in FIG. 9 can be used in various systems discussed in connection with other figures of the present disclosure. In FIG. 9, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 9. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 9. For example, in one embodiment, the transaction terminal (105) is an ATM machine, which includes components to dispense cash under certain conditions.

### Account Identification Device

FIG. 10 illustrates an account identifying device according to one embodiment. In FIG. 10, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 10, such as a cellular communications subsystem.

In one embodiment, the communication device (159) may access the account information (142) stored on the memory (167) without going through the processor (151).

In one embodiment, the account identification device (141) has fewer components than those illustrated in FIG. 10. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with, or near, the transaction terminal (105) (e.g., a video monitor or display, a digital sign), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used to primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 11, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Hardware

In one embodiment, a computing apparatus is configured to include some of the components of systems illustrated in various figures, such as the transaction handler (103), the profile generator (121), the media controller (115), the portal (143), the profile selector (129), the advertisement selector (133), the user tracker (113), the correlator, and their associated storage devices, such as the data warehouse (149).

In one embodiment, at least some of the components such as the transaction handler (103), the transaction terminal (105), the point of interaction (107), the user tracker (113), the media controller (115), the correlator (117), the profile generator (121), the profile selector (129), the advertisement selector (133), the portal (143), the issuer processor (145), the acquirer processor (147), and the account identification device (141), can be implemented as a computer system, such as a data processing system (170) illustrated in FIG. 11, with more or fewer components. Some of the components may share hardware or be combined on a computer system. In one embodiment, a network of computers can be used to implement one or more of the components.

Further, the data illustrated in the figures, such as transaction data (109), account data (111), transaction profiles (127), and advertisement data (135), can be stored in storage devices of one or more computers accessible to the corresponding components. For example, the transaction data (109) can be stored in the data warehouse (149) that can be implemented as a data processing system illustrated in FIG. 11, with more or fewer components.

In one embodiment, the transaction handler (103) is a payment processing system, or a payment card processor, such as a card processor for credit cards, debit cards, etc.

FIG. 11 illustrates a data processing system according to one embodiment. While FIG. 11 illustrates various components of a computer system, it is not intended to represent any particular architecture or manner of interconnecting the components. One embodiment may use other systems that have fewer or more components than those shown in FIG. 11.

In FIG. 11, the data processing system (170) includes an inter-connect (171) (e.g., bus and system core logic), which interconnects a microprocessor(s) (173) and memory (167). The microprocessor (173) is coupled to cache memory (179) in the example of FIG. 11.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented system having at least one microprocessor and memory storing instructions configured to instruct the at least one microprocessor to perform operations, the system comprising:
a transaction handler configured to interconnect issuer processors and acquirer processors in a payment processing network, wherein each of the issuer processors is configured to make payments on behalf of consumers using consumer accounts issued to the consumers, and each of the acquirer processors configured to receive payments on behalf of merchants using merchant accounts set up for the merchants;
a data warehouse coupled with the transaction handler and configured to store transaction data recording payment transactions processed by the transaction handler;
a portal coupled with the data warehouse and configured to provide a user interface for registration of different loyalty reward programs, wherein when a user of a consumer account registers a loyalty reward program using the user interface, the portal is configured to store in the data warehouse data associating the consumer account of the user with the loyalty reward program; and
a loyalty broker coupled with the transaction handler and configured to exchange loyalty benefits provided in the loyalty reward programs for loyalty benefits provided by the transaction handler, wherein after the data warehouse stores the data associating the consumer account of the user with the loyalty reward program, the loyalty broker is configured to communicate with a provider of the loyalty reward program to exchange loyalty benefits of the loyalty reward program offered to the user for loyalty benefits provided by the transaction handler in payment transactions made in the consumer account of the user.

2. The system of claim 1, wherein the loyalty broker is configured to exchange, at a time for authorization of a use of loyalty benefits, the loyalty benefits of the loyalty reward program offered to the user for the loyalty benefits provided by the transaction handler.

3. The system of claim 1, wherein the loyalty broker is configured to exchange, periodically in accordance with a set of predefined preferences of the user, the loyalty benefits of the loyalty reward program offered to the user for the loyalty benefits provided by the transaction handler in payment transactions made in the consumer account of the user.

4. The system of claim 1, wherein the loyalty broker is configured to exchange, in an automated way based on a set of predefined preferences, the loyalty benefits of the loyalty reward program offered to the user for the loyalty benefits provided by the transaction handler in payment transactions made in the consumer account of the user.

5. The system of claim 4, wherein the set of predefined preferences includes a threshold which, when exceeded by the loyalty benefits of the loyalty reward program offered to the user, causes the loyalty broker to exchange the loyalty benefits of the loyalty reward program offered to the user for the loyalty benefits provided by the transaction handler in payment transactions made in the consumer account of the user.

6. The system of claim 1, wherein the loyalty broker is configured to exchange, in response to a user request received in the portal, the loyalty benefits of the loyalty reward program offered to the user for the loyalty benefits provided by the transaction handler in payment transactions made in the consumer account of the user.

7. The system of claim 1, wherein in a payment transaction between the user and a merchant, made using the consumer account of the user, the merchant is reimbursed for a price discount, applied via the transaction handler to the payment transaction as the loyalty benefits provided by the transaction handler to the payment transaction.

8. The system of claim 7, wherein an amount for the loyalty benefits provided by the transaction handler to the payment transaction is specified by the user in initiating the payment transaction.

9. The system of claim 8, wherein the merchant is allowed to manage offers for redemption of loyalty benefits by specifying an exchange rate of loyalty benefits and price discounts; wherein the merchant is reimbursed according to the exchange rate.

10. The system of claim 9, wherein the merchant sponsors a discount via specifying the exchange rate that is lower than a current exchange rate between respective loyalty benefits and currency backing the respective loyalty benefits.

11. The system of claim 8, wherein when the merchant provides no offers in association with redemption of loyalty benefits, the price discount is based on currency backing the amount of loyalty benefits specified by the user and provided by the transaction handler to the payment transaction.

12. The system of claim 7, further comprising:
a message broker configured to generate a confirmation alert when redemption of the amount of loyalty benefits specified by the user is authorized in the payment transaction; and
a media controller coupled with the message broker to transmit the confirmation alert to a communication reference stored in the data warehouse in association with the consumer account.

13. The system of claim 7, wherein the provider of the loyalty reward program is different from an issuer processor in control of the consumer account of the user.

14. The system of claim 13, wherein settlement of the loyalty benefits provided by the transaction handler to the payment transaction is integrated with settlement of the payment transaction.

15. The system of claim 1, wherein the loyalty benefits provided by the transaction handler in payment transactions made in the consumer account of the user are hosted in the data warehouse.

16. The system of claim 15, wherein the loyalty benefits hosted in the data warehouse can be earned from a plurality of participating merchants and used as a payment currency via the transaction handler.

17. The system of claim 16, wherein the loyalty benefits hosted in the data warehouse are transferable among users via benefit tokens.

18. The system of claim 15, wherein the loyalty benefits hosted in the data warehouse are not fixedly associated with any government issued currency.

19. A computer-implemented method, comprising:
receiving, in a computing apparatus, registration information to associate account information of a payment account with at least one loyalty account to enable conversion of first loyalty benefits to second loyalty benefits;
receiving, in the computing apparatus and for a transaction, an authorization request identifying the account information and requesting use of the second loyalty benefits to fund at least a portion of the transaction; and
processing the transaction using the second benefits converted from the first loyalty benefits hosted in the loyalty account and funds from the payment account.

20. A non-transitory computer storage medium storing instructions configured to instruct a computing apparatus at least to:
receive, in the computing apparatus, registration information to associate account information of a payment account with at least one loyalty account to enable conversion of first loyalty benefits to second loyalty benefits;
receive, in the computing apparatus and for a transaction, an authorization request identifying the account information and requesting use of the second loyalty benefits to fund at least a portion of the transaction; and
process the transaction using the second benefits converted from the first loyalty benefits hosted in the loyalty account and funds from the payment account.
